(19) United States
(12) Patent Application Publication
(10) Pub. No.: US 2007/0111845 A1
(43) Pub. Date: May 17, 2007

(54) Driving mechanism and door closing apparatus for vehicle

(75) Inventors: Shigeru Hayakawa, Chiryu-shi (JP); Motohiro Kokubo, Kariya-shi (JP); Toshitsugu Oda, Okazaki-shi (JP); Tsutomu Kobayashi, Toyohashi-shi (JP); Nobuko Watanabe, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/600,089

(22) Filed: Nov. 16, 2006

(30) Foreign Application Priority Data
Nov. 17, 2005 (JP) 2005-333259
Nov. 17, 2005 (JP) 2005-333260
Nov. 17, 2005 (JP) 2005-333261
Nov. 17, 2005 (JP) 2005-333262

(51) Int. Cl. F16H 3/44

(52) U.S. Cl. 475/317

(57) ABSTRACT

A driving mechanism includes: a drive gear fixed to a motor; a sun gear rotatably provided and having a gear portion engaged with the drive gear; a ring gear coaxial with the sun gear and locked not to rotate relative to the sun gear and being allowed to rotate relative to the sun gear; a planetary gear engaged with the sun gear and the ring gear; a planetary carrier coaxial with the sun gear and connected to the planetary gear, the planetary carrier outputting force in response to rotation and revolution of the planetary gear associated with rotation of the sun gear and relative to the ring gear locked not to rotate. A central engaged portion of the driving gear and the gear portion and a central engaged portion of the sun gear, the ring gear and the planetary gear are arranged on the same plane.

### CROSS REFERENCE TO RELATED APPLICATIONS

This application is based on and claims priority under 35 U.S.C. § 119 to Japanese Patent Application 2005-333259, 2005-333260, 2005-333261 and 2005-333262, all of which were filed on Nov. 17, 2005, the entire content of which is incorporated herein by reference.

### FIELD OF THE INVENTION

The present invention relates to a driving mechanism and a door closing apparatus for vehicle.

### BACKGROUND

It has been conventionally known a door closing apparatus for a vehicle, for example disclosed in JP2002-250165A (FIGS. 1-3, U.S. 2002-119861A1). According to a driving mechanism, which is provided in the door closing apparatus, rotational torque of an electric motor is inputted into a sun gear of a planetary gear mechanism, and each planetary gear rotates and revolutes relative to a ring gear fixed against rotation by an engagement cancel block of a connection interrupting mechanism. In response to rotation of a planetary carrier associated with rotation of each planetary gear, an output shaft rotates so as to output operation force for shifting a latch mechanism from a half-latched state to a fully latched state. As a result, a closing operation is implemented for operating a door from a half-closed state to a fully closed state. The ring gear is fixed against rotation with external teeth engaged with teeth of the engagement cancel block.

Meanwhile, when a door handle is operated to open a door, this operation force is inputted into the engagement cancel block. The engagement cancel block retracts backward and the ring gear is allowed to rotate, wherein torque transmission between the electric motor and the output shaft is discontinued. At the same time, when the door handle is operated to open the door, operation force for releasing the latch mechanism from a latched state is outputted, wherein the door can open.

According to the door closing apparatus disclosed above, the sun gear exhibits a substantially cylindrical shape with a bottom so as not to interfere with the planetary gears. A worm is firmly attached to a rotational shaft of the electric motor. The sun gear is formed with a worm wheel portion, which is engaged with the worm, such that the sun gear of the planetary gear mechanism is operatively connected to the worm. Meanwhile, the ring gear exhibits a substantially cylindrical shape with a bottom so as to house the planetary gears therein. The ring gear is formed with external teeth, which are engaged with the teeth of the engagement cancel block, at an outer peripheral surface. For the purpose of avoiding mutual interference between the worm wheel portion and the ring gear, the worm wheel portion and the ring gear are arranged on a different plane in the axial direction and are cumulated in the axial direction.

Therefore, the central engagement portion of the worm and the worm wheel portion is shifted in the axial direction relative to the central engagement portion of the ring gear, the sun gear and the planetary gears. Further, the electric motor is positioned on the basis of a rotation shaft (rotational axis) defining the central engagement portion of the worm and the worm wheel portion. Accordingly, the electric motor is positioned at one side of an axis of the planetary gear mechanism, which may increase the thickness and size of an entire structure of the driving mechanism. Especially, in a situation in which this driving mechanism is housed in a door for a vehicle, the freedoms or possibilities for positioning the driving mechanism are reduced because of this upsizing.

It has been conventionally known a door closing apparatus for a vehicle, in which driving force of a driving mechanism is transmitted to a latch mechanism via drive cable and a vehicle door at the half-closed state is shifted to a fully closed state. JP09-42265A (FIG. 3) discloses a structure for assembling a drive cable on a door closing apparatus for a vehicle. An outer tube of the drive cable is inserted into a bore of an attachment wall standing up at a base member. The drive cable is prevented from dropping out and fixed by fastening the end of the drive cable by nuts from both sides of the attachment wall.

In this case, in order to fix the end of the drive cable, it was necessary to first insert the outer tube into the first nut and insert into the bore and the second nut. Therefore, a fixing performance was low. Especially, in order to stabilize the behavior of the drive cable, it is general to arrange the end of the drive cable in the vicinity of a member to be linked. This may force a fastening of nuts in a limited space with a deteriorated workability.

Meanwhile, in order to avoid complexity for inserting the drive cable (outer tube) in the axial direction as described above, it is possible to open the attachment wall in a U-shaped structure and to press-fit the outer tube into this opening in a radial direction, wherein the drive cable is prevented from dropping and is fixed stably. However, because the drive cable is required to have tension at a level sufficient for transmitting force between the driving mechanism and the latch mechanism, the drive cable is designed to have large rigidity. This may require a large force to press-fit the drive cable, force that is not achieved by general jigs.

The present invention has been made in view of the above circumstances, and provides a driving mechanism and a door closing apparatus for a vehicle, both of which have a reduced size, and the door closing apparatus in which a fixedly assembling performance of an end of a drive cable for transmitting driving power of the driving mechanism to the latch mechanism is enhanced.

### SUMMARY OF THE INVENTION

According to an aspect of the present invention, a driving mechanism includes: a drive gear fixed at a rotational shaft of a motor; a sun gear rotatably provided and having a gear portion engaged with the drive gear; a ring gear arranged coaxially with the sun gear, the ring gear being locked not to rotate relative to the sun gear and being allowed to rotate relative to the sun gear; a planetary gear engaged with the sun gear and the ring gear; and a planetary carrier arranged coaxially with the sun gear and connected to the planetary gear. The planetary carrier outputs rotational force in response to rotation and revolution of the planetary gear operatively associated with rotation of the sun gear and relative to the ring gear locked not to rotate. A central engaged portion of the driving gear and the gear portion and a central engaged portion of the sun gear, the ring gear and the planetary gear are arranged on the same plane.

According to another aspect of the present invention, a door closing apparatus for a vehicle includes a planetary gear mechanism having a sun gear, a ring gear, a planetary gear and a planetary carrier. An input shaft is selected from among the sun gear, the ring gear, the planetary gear and is rotatably driven by an electric motor. A fixed shaft is selected from among the sun gear, the ring gear and the planetary gear and is different from the input shaft. An output shaft is selected from among the sun gear, the ring gear, the planetary gear and is different from the input shaft and the fixed shaft. The door closing apparatus for the vehicle further includes: a first engagement portion formed at the fixed shaft of the planetary gear mechanism; a latch mechanism holding a door of the vehicle at a half-closed state and a fully closed state; a locking member having a second engagement portion. The locking member locks the fixed shaft not to rotate with the second engagement portion engaged with the first engagement portion of the fixed shaft and unlocks the fixed shaft to rotate with the second engagement portion disengaged from the first engagement portion of the fixed shaft. The door closing apparatus still further includes power transmitting means for transmitting force outputted by the output shaft to the latch mechanism so that the latch mechanism is operated to shift the door from the half-closed state to the fully closed state in a state where the locking member is engaged with the ring gear; and switching means for switching an engagement or disengagement between the first engagement portion and the second engagement portion. The switching means releases an engagement between the first engagement portion and the second engagement portion by transmitting an operation force to the locking member and engages the first engagement portion and the second engagement portion by discontinuing transmission of the operation force to the locking member, regardless of the force transmission by the power transmitting means. The first engagement portion and the second engagement portion are formed in a serrated manner so that the first engagement portion and the second engagement portion are engaged smoothly in a rotational direction of the fixed shaft.

According to still another aspect of the present invention, a door closing apparatus for a vehicle includes: a planetary gear mechanism having a sun gear, a ring gear, a planetary gear and a planetary carrier. An input shaft is selected from among the sun gear, the ring gear, the planetary gear and is rotatably driven by an electric motor. A fixed shaft is selected from among the sun gear, the ring gear and the planetary gear and is different from the input shaft. The fixed shaft is locked not to rotate by being engaged with a locking member and is unlocked to rotate by being disengaged from the locking member. An output shaft is selected from among the sun gear, the ring gear, the planetary gear and is different from the input shaft and the fixed shaft. The door closing apparatus further includes: a latch mechanism holding a door of the vehicle at a half-closed state and a fully closed state; power transmitting means for transmitting force outputted by the output shaft to the latch mechanism so that the latch mechanism is operated to shift the door from the half-closed state to the fully closed state in a state where the locking member is engaged with the ring gear; and switching means for switching an engagement or disengagement between the locking member and the fixed shaft. The switching means releases an engagement between the locking member and the fixed shaft by transmitting an operation force to the locking member and engages the locking member and the fixed shaft by discontinuing transmission of the operation force to the locking member, regardless of the force transmission by the power transmitting means. The door closing apparatus further includes an elastic body provided at an axial portion of at least one of the sun gear, the ring gear and the planetary gear.

### BRIEF DESCRIPTION OF THE DRAWINGS

The foregoing and additional features and characteristics of the present invention will become more apparent from the following detailed description considered with reference to the accompanying drawings, wherein:

FIG. 1 is a front view illustrating a door for a vehicle according to an embodiment of the present invention;

FIG. 2 is an aerial view illustrating the door for the vehicle;

FIG. 3 is a front view illustrating a door latch apparatus;

FIG. 4 is a side view illustrating the door latch apparatus;

FIG. 5 is another front view illustrating the door latch apparatus;

FIG. 6 is another front view illustrating the door latch apparatus;

FIG. 7 is a front view illustrating an actuator;

FIG. 8A is a side view illustrating the actuator;

FIG. 8B is another side view illustrating the actuator;

FIG. 9 is a cross sectional view taken along line IX-IX in FIG. 8;

FIG. 10A is an enlarged view illustrating the actuator;

FIG. 10B is another enlarged view illustrating the actuator;

FIG. 11A is a cross sectional view taken along line XIA-XIA in FIG. 7; and

FIG. 11B is a cross sectional view taken along line XIB-XIB in FIG. 7.

### DETAILED DESCRIPTION

An embodiment of the present invention will be described below with reference to the attached drawing figures.

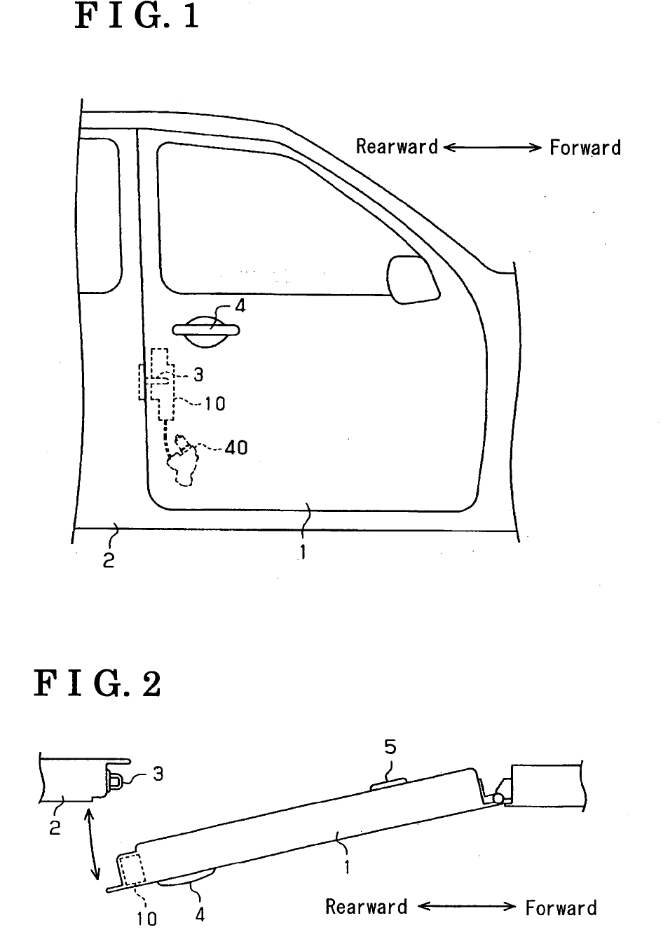

FIG. 1 is a front view illustrating a door 1 for a vehicle according to the embodiment of the present invention. FIG. 2 is an aerial view illustrating the door 1. The door 1 for a vehicle is hinged to a body 2 and opens and closes an opening of the body 2, i.e., the door 1 is a swing-type door. A door latch unit 10 is mounted at a vehicle rearward end in the door 1. The door latch unit 10 is engaged with or disengaged from a U-shaped or C-shaped striker 3 fixed to the body 2 so as to hold the door 1 at a half-closed state or a fully closed state. The door latch unit 10 is connected to an outside door handle 4 and an inside door handle 5, each of which is provided at an outside and inside of the door 1. When the door latch unit 10 is transmitted with operation force from either the outside door handle 4 or the inside door handle 5, the door latch unit 10 is disengaged from the striker 3 and the door 1 is allowed to open.

The door latch unit 10 is further connected to an actuator 40, which serves as a driving mechanism and is mounted inside the door 1. When the door latch unit 10 is transmitted with driving force of the actuator 40, the door latch unit 10 is engaged with the striker 3 in a way that the door 1 is shifted from the half-closed state to the fully closed state. The actuator 40 is connected to each of the outside door handle 4 and the inside door handle 5, and driving force transmission from the actuator 40 to the door latch unit 10 is discontinued in response to operation force transmitted from either the outside door handle 4 or the inside door handle 5 to the actuator 40.

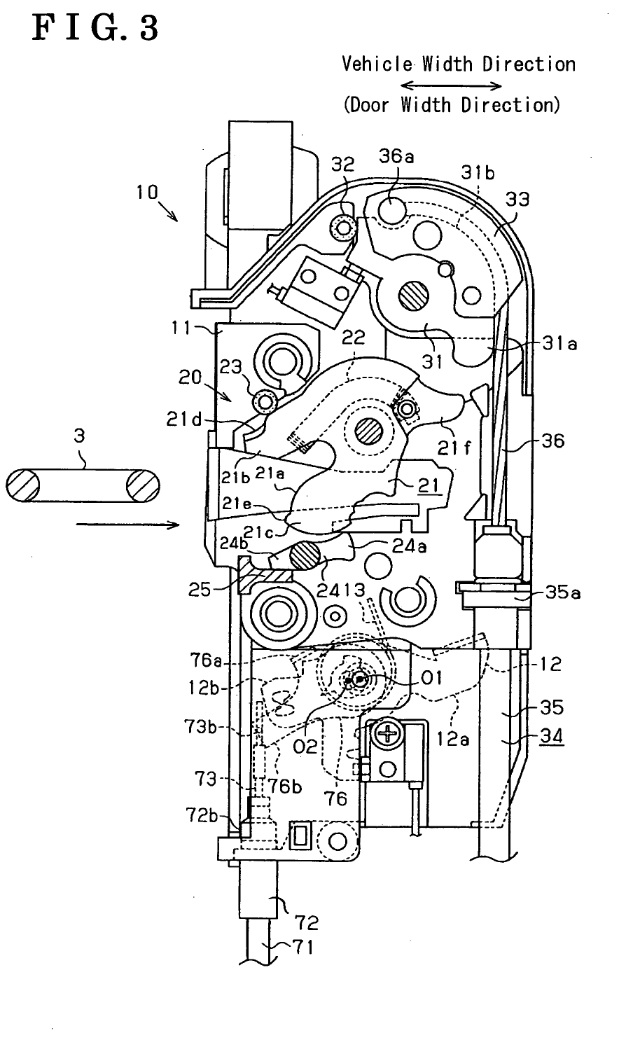

Described below is a structure of the door latch unit 10 with reference to FIGS. 3, 4, 5 and 6.

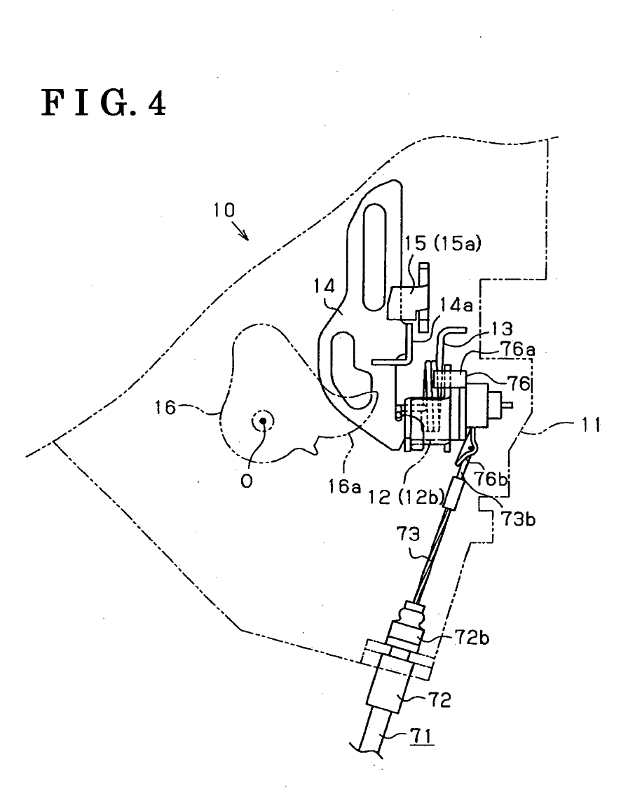

FIG. 3 is a front view of the door latch unit 10 and corresponds to a view viewed from a rear side of the vehicle. FIG. 4 is a side view of the door latch unit 10 and corresponds to a view viewed from an inside of the vehicle in a width direction. As illustrated therein, inside a main body 11, which forms an outer profile of the door latch unit 10 and houses or supports various components therein, an open lever 12, which is made of a plate material, is supported to be pivotable about a first rotational shaft O1. The open lever 12 is biased by a torsion spring 13, which is wound around the first rotational shaft O1, and is retained at a predetermined pivot position. The open lever 12 is linked, at an end 12a, to the outside door handle 4 via known mechanical connecting members. When the open lever 12 is transmitted with operation force of the outside door handle 4, the open lever 12 pivots clockwise in FIG. 3 against the biasing force of the torsion spring 13, and the other end 12b of the open lever 12 is lifted up (left side in FIG. 3). On the other hand, when the outside door handle 4 is discontinued from being operated, the open lever 12 is biased by the torsion spring 13 and pivots counterclockwise in FIG. 3 so that the other end 12b of the open lever 12 is lifted down. The open lever 12 then returns to the predetermined pivot position.

As illustrated in FIG. 4, an open link 14, which is made of a plate, is pivotably supported, at a lower end thereof, by the other end 12b of the open lever 12. The open link 14 is formed with an L-shaped flange 14a at an intermediate portion in an up and down direction. The L-shaped flange 14a is positioned so as to face from below a distal end 15a of a lift lever 15, which is made of a plate and is rotatably supported by the main body 11.

Further as illustrated in FIG. 4, inside the main body 11, an inside open lever 16, which is made of a plate, is rotatably supported about a rotational shaft O. The inside open lever 16 includes a distal end 16a, which extends in a radial outward direction and is arranged so as to face the flange 14a from below. The inside open lever 16 is linked to the inside door handle 5 via known mechanical connecting members. When the inside open lever 16 is transmitted with operation force of the inside door handle 5, the inside open lever 16 rotates counterclockwise in FIG. 4 and the distal end 16a is lifted up. On the other hand, when the inside door handle 5 is discontinued from being operated, the inside open lever 16 rotates clockwise in FIG. 4 and the distal end 16a is lifted down. The inside open lever 16 is biased by the torsion spring 13 up to an initial position of the open link 14 and is biased to an initial position of the inside open lever 16 by the inside door handle 5. The inside open lever 16 then returns to a predetermined pivot position.

As illustrated in FIG. 3, inside the main body 11, a latch 21 is rotatably supported at an upper side of the open lever 12. The latch 21 includes an engagement recess 21a and exhibits a U-shaped structure. The latch 21 includes a first detent 21b, which is formed at an end of the latch 21 in a clockwise direction in FIG. 3, and a second detent 21c, which is formed at the other end of the latch 21 in a counterclockwise direction in FIG. 3. The engagement recess 21a is interposed between the first and second detents 21b and 21c. The first detent 21b includes a first engagement portion 21d facing an opposite side to the engagement recess 21a. The second detent 21c includes a second engagement portion 21e facing the engagement recess 21a at an end of the second detect 21c. The latch 21 further includes a driven portion 21f extending toward the opposite side to the engagement recess 21a relative to the rotational axis. A latch biasing spring 22 is housed in the main body 11, one end of which is fixed by the main body 11 and the other end of which is fixed at the latch 21. The latch 21 is then biased towards a clockwise rotation direction. The clockwise rotation of the latch 21 is restrained with a surface of the first detent 21b in contact with a latch stopper 23 firmly attached to the main body 11, wherein the latch 21 is retained at a predetermined pivot position.

Further, in the main body 11, a pole 24 is rotatably supported between the open lever 12 and the latch 21. This pole 24 is connected to the lift lever 15 so as to rotate integrally therewith. The pole 24 includes an engagement portion 24a, which extends to one side from a rotational axis (toward the right side in FIG. 3), and an extending portion 24b, which extends to the other side from the rotational axis (toward the left side in FIG. 3). The pole 24 is biased by a pole biasing spring (not illustrated), one end of which is supported by the main body 11 and the other end of which is supported by the pole 24. The pole 24 is biased by the pole biasing spring towards a counterclockwise direction, i.e., in a direction for lifting up the engagement portion 24a. The further counterclockwise rotation of the pole 24 is restrained with a ball stopper 25, which is provided at the main body 11, in contact with a surface of the extending portion 24bm wherein the pole 24 is retained at a predetermined pivot position. The pole 24 configures a latch mechanism 20 with the latch 21 and so on.

Described below is a fundamental operation of the latch mechanism 20. As illustrated in FIG. 3, when the door 1 is open, the latch 21 is being retained at the predetermined pivot position with the latch stopper 23 in contact with the surface of the first detent 21b. The engagement recess 21a is open facing an approach patch of the striker 3 in response to a closing operation of the door 1. The pole 24 is being retained at the predetermined pivot position with the ball stopper 25 in contact with the surface of the extending portion 24b. The engagement portion 24a is positioned below the second detent 21c. In this case, the latch mechanism 20 is set at an unlatched state.

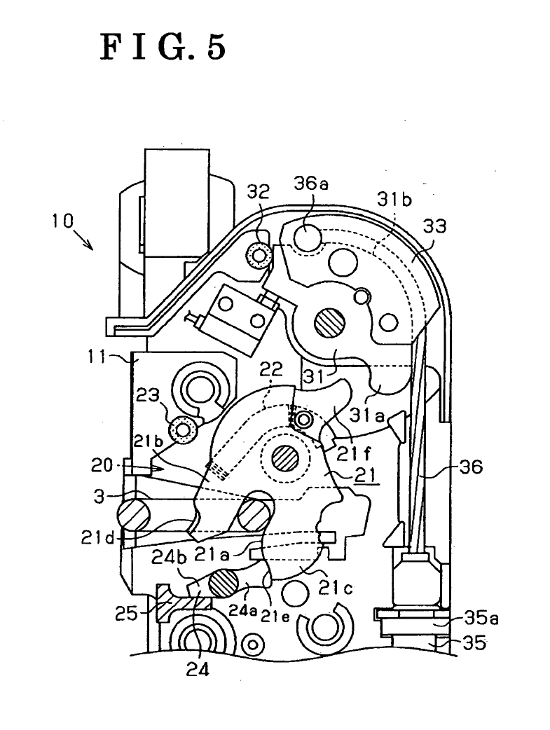

When the striker 3 enters into the engagement recess 21a in response to the closing operation of the door 1, the striker 3 pushes an inner wall surface of the engagement recess 21a. The latch 21 then rotates counterclockwise against the biasing force of the latch biasing spring 22, as illustrated in FIG. 5. The second engagement portion 21e of the latch 21 comes in contact with the engagement portion 24a so that the latch 21 is locked against clockwise rotation. Here, the door 1 is at the half-closed state in which the striker 3 is engaged with the engagement recess 21a and is blocked from dropping or moving away. The latch mechanism 20 is at the half-latched state.

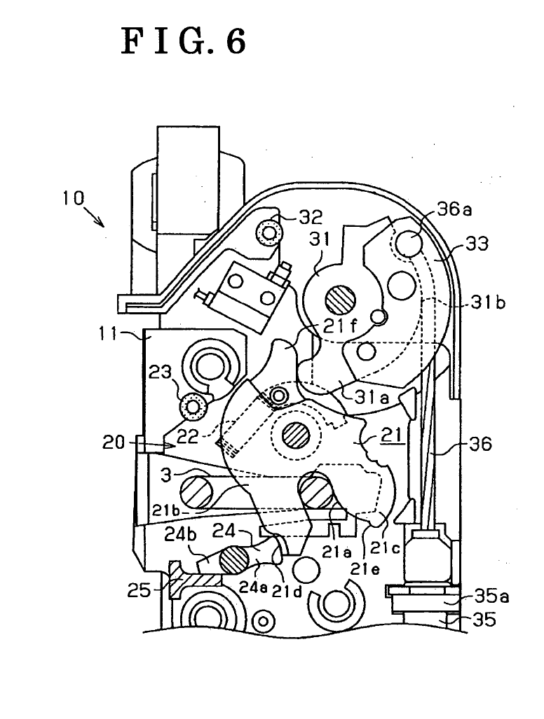

When the striker 3 further enters into the engagement recess 21a as the door 1 is further closed, the striker 3 pushes the inner wall surface of the engagement recess 21a. As illustrated in FIG. 6, the latch 21 further rotates counterclockwise against the biasing force of the latch biasing spring 22, and the engagement portion 24a is engaged with the first engagement portion 21d. Here, the door 1 is at the fully closed state in which the striker 3 is engaged with the engagement recess 21a and is blocked from dropping or moving away. The latch mechanism 20 is at the fully latched state.

When the pole 24 rotates clockwise against the biasing force of the pole biasing spring with the latch 21 at the half-latched state or fully latched state, the engagement of the engagement portion 24a with the first engagement portion 21d or the second engagement portion 21e is released. Here, the latch 21 is biased by the latch biasing spring 22 and rotates clockwise while the inner wall surface of the engagement recess 21a is pushing the striker 3. The striker 3 is disengaged from the engagement recess 21a and the door 1 is opened.

As illustrated in FIG. 3, an operation lever 31 is pivotably supported at an upper side of the latch 21 inside the main body 11. The operation lever 31 is formed with a drive portion 31a extending at its one end toward the lower side in FIG. 3. A lever biasing spring (not illustrated) is supported, at its one end, by the main body 11, and the other end thereof is engaged with the operation lever 31, wherein the operation lever 31 is biased to pivot counterclockwise in FIG. 3. The operation lever 31 comes in contact with a lever stopper 32, which is provided at the main body 11, and is prohibited from rotating further counterclockwise and is retained at a predetermined pivot position. When the latch mechanism 20 at the half-latched state, the drive portion 31a is arranged in a way that the driven portion 21f of the latch 21 is positioned on a pivot-movement path of the drive portion 31a, as illustrated in FIG. 5.

The operation lever 31 is formed with an arc-shaped guiding surface 31b at the upper side of a rotational shaft of the operation lever 31. The guiding surface 31b is interposed between two planar shaped guiding plates 33. FIG. 3 illustrates only one guiding plate 33. Further in the main body 11, an end 35a of an outer tube 35, which includes a drive cable 34, is supported at the lower side of the operation lever 31. The guiding plates 33 supports one end 36a of a drive wire 36, which is pulled out from the end 35a of the outer tube 35 and guided by the guiding surface 31b. Therefore, when the drive wire 36 retracts into the end 35a of the outer tube 35, the operation lever 31, which is fixed with the guiding plates 33, rotates clockwise against the biasing force of the lever biasing spring. Mores specifically, the drive wire 36 (drive cable 34) is connected to the actuator 40. When driving force of the actuator 40 is transmitted to the drive wire 36, the drive wire 36 retracts into the end 35a of the outer tube 35 such that the operation lever 31 pivotably rotates clockwise.

When the drive wire 36 is retracted towards the outer tube 35 in a situation where the latch mechanism 20 is at the half-latched state, the operation lever 31 rotates clockwise and the drive portion 31a of the operation lever 31 pushes the driven portion 21f of the latch 21. As a result, the latch 21 rotates counterclockwise against the biasing force of the latch biasing spring 22. The striker 3, which is to be engaged with the engagement recess 21a of the latch 21, is pulled and the latch mechanism 20 is shifted to the fully latched state, as illustrated in FIG. 6. Here, a door closing operation is implemented in a way that the door 1 is shifted from the half-closed state to the fully closed state.

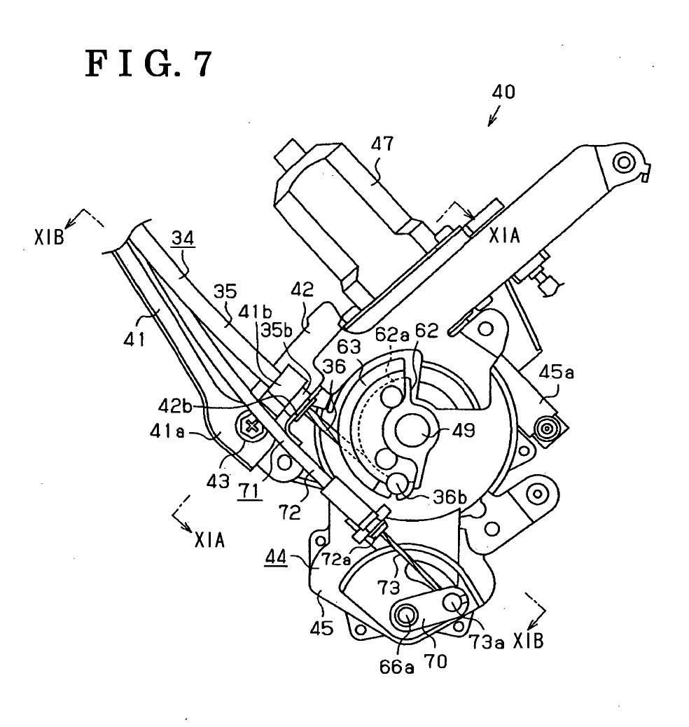

Described below is a structure of the actuator 40 with reference to FIGS. 7, 8 and 9.

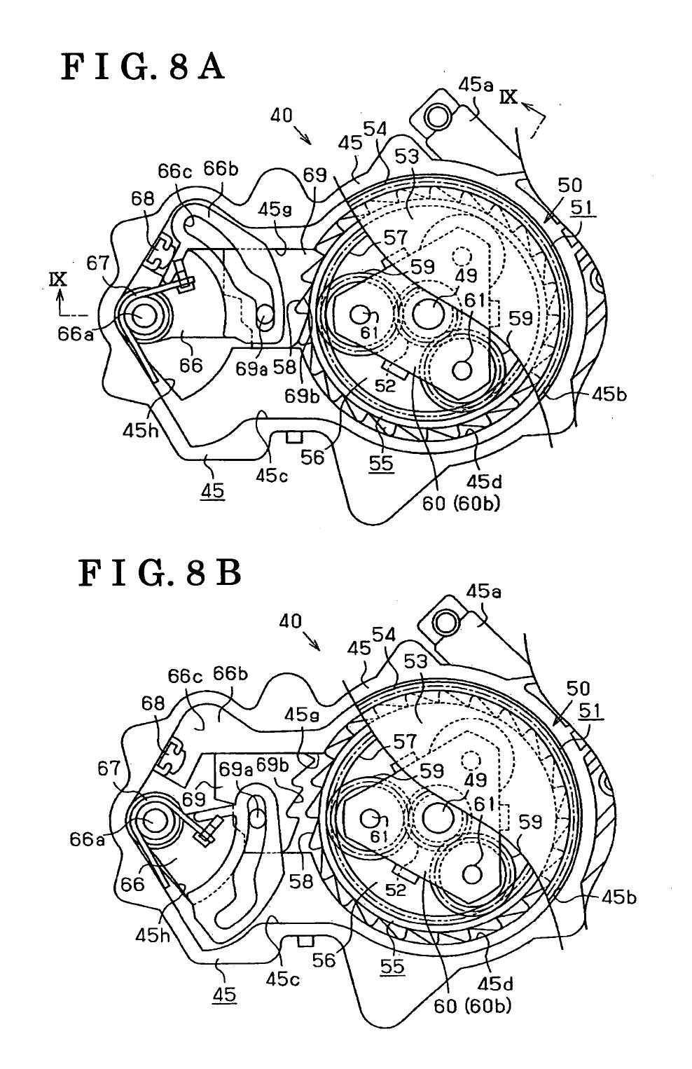

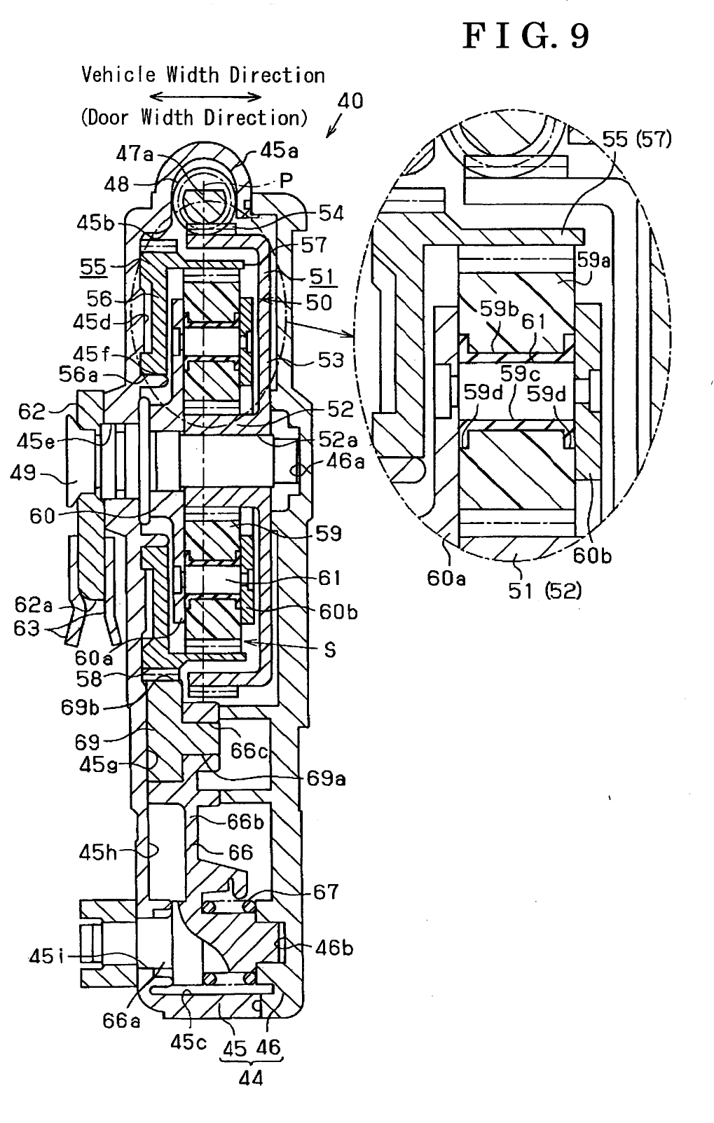

FIG. 7 is a front view illustrating the actuator 40 and corresponds to a view viewed from a laterally outside of the vehicle. FIG. 8 is a back view of the actuator 40. FIG. 9 is a cross sectional vie taken along line IX-IX in FIG. 8. As illustrated in FIG. 7, a plate-made and rectangular shaped bracket 41 is fastened, at its one end 41a, to a plate-made supporting bracket 42 by means of a screw 43. The other end of the bracket 41 is fastened to main body 11 of the door latch unit 10, which is not illustrated. A housing 44, which forms an outer shape of the actuator 40 and houses and supports various components, is fastened to the supporting bracket 42 so that the actuator 40 is fixed to and supported by the door latch unit 10 via the bracket 41. As illustrated in FIG. 9, the housing 44 includes a case 45 of cylindrical shaped with a bottom, in which various components are housed, and a cover 46, which closes an opening of the case 45.

As illustrated in FIGS. 7 and 9, an axis of the case 45 extends, at an end of one side (upper right in FIG. 7) to the one side (lower right in FIG. 7). The case 45 includes a worm housing portion 45a, which exhibits a cylindrical shape and open partially at the side of the housing portion 45a (lower side in FIG. 9), at the upper side in FIG. 9. In the worm housing portion 45a, a worm 48, which serves as a drive gear and is firmly attached to a rotational shaft 47a of an electric motor 47 fastened to the case 45, is rotatably housed. The electric motor 47 is controlled to actuate by a controller which is not illustrated and rotates the rotational shaft 47a (worm 48) in a normal or reverse rotational direction.

As illustrated in FIGS. 8 and 9, the case 45 includes a gear housing portion 45b, which exhibits an approximately cylindrical-shape with a bottom and is partially notched to form the cylindrical shape of the worm housing portion 45a. The gear housing portion 45b is formed so as to open at a radially one end (the left side in FIGS. 8A and 8B). The case 45 includes a housing 45c which exhibits a polygonal cylindrical shape and communicates with an opening side (left side in FIG. 8) of the gear housing portion 45b. That is, the bottom wall of the case 45 exhibits a shape combined with a circle and a polygon.

The gear housing portion 45b includes a recess 45d, which has an inner diameter smaller than a diameter of the gear housing portion 45b and is recessed in a circular from a bottom wall of the gear housing portion 45b. The recess 45d is formed with a bearing bore 45e at a center of its bottom wall (see FIG. 9). The bearing bore 45e is fitted with one end of an output shaft 49 so as to freely rotate. An axis of the output shaft 49 extends along an axis of the gear housing portion 45b. A distal end of the output shaft 49 extends outside of the case 45 (housing 44). The other end of the output shaft 49 is supported at a recess 46a formed at the cover 46 so as to be rotatable and not to be movable to an axial one side, i.e., to the right side in FIG. 9.

A sun gear 51 is housed in the gear housing portion 45b at the side of the cover 46. The sun gear 51 is formed with a sun gear portion 52, a disc-shaped flange 53 and a worm wheel portion 54. An inner diameter of the cylindrical sun gear portion 52 is substantially identical to an outer diameter of the output shaft 49. The flange 53 extends radially outwardly at one axial end (right in FIG. 9) of the sun gear portion 52. The worm wheel portion 54 extends from a periphery of the flange 53 towards the other axial end (left in FIG. 9) and exhibits a cylindrical shape. The worm wheel portion 54 serves as a gear portion engageable with the worm 48. The sun gear portion 52, the flange 53 and the worm wheel portion 54 of the sun gear 51 forms a cylindrical box-shaped portion with a bottom, and formed within it is a ring-shaped housing space S. An inner peripheral surface of the sun gear portion 52 serves as a bearing bore 52a into which the output shaft 49 is relative-rotatably fitted. The sun gear portion 52 is formed to lie over or overlap the worm wheel portion 54 in the axial direction.

The recess 45d is formed with a cylindrical projection 45f, which projects towards the cover 46 and is coaxial with the bearing bore 45e. The projection 45f supports a ring gear 55 to be freely rotatable. The ring gear 55 exhibits a cylindrical shape with a bottom and possesses an outer diameter smaller than the inner diameters of the worm wheel portion 54 and the recess 45d. The ring gear 55 is formed with a bottom wall portion 56 and a cylindrical ring-shaped gear portion 57. The bottom wall portion 56 includes a bearing bore 56a into which the projection 45f is fitted. The cylindrical ring gear portion 57 extends from a periphery of the bottom wall portion 56 towards the axial one end (right in FIG. 9). The ring gear portion 57 is arranged to be at the same position along the axial direction as the sun gear portion 52 in a way that a distal end of the ring gear portion 57 is housed inside the housing space S of the sun gear 51. The ring gear portion 57 is formed with engagement nails 58 at the base side that is shifted from the axial position of the worm wheel portion 54. The engagement nails 58 are designed at a predetermined pitch over an entire circumference of the ring gear portion 57 and serve as plural first engagement portions.

Multiple planetary gears 59 are arranged at a predetermined angle between the sun gear portion 52 and the ring gear portion 57 and are gear-meshed therewith. According to the first embodiment of the present invention, provided are three planetary gears 59. Each planetary gear 59 is arranged at the same position along the axial direction as the sun gear portion 52 and the gear portion 57. That is, the central engaged portion of the worm 48 and the worm wheel portion 54 and the central engaged portion of the sun gear 51 (sun gear portion 52), the ring gear 55 (gear portion 57) and the planetary gears 59 are arranged on the same imaginary surface P (the same plane P) in FIG. 9. The aforementioned central engaged portion is determined at an arbitrary position at an intermediate within a range in which plural gears are mutually gear-meshed and does not represent an accurate center. Further, as described above, the central engaged portions are arranged at the same plane. That is, all the engagement centers are positioned on a predetermined imaginary surface perpendicular with the axis of the sun gear 51 (sun gear portion 52) within the axial directional range of the sun gear 51. Especially, the worm 48, which is gear-meshed with the worm wheel portion 54, has the axis positioned on the same imaginary surface P.

The output shaft 49 is firmly attached with a planetary carrier 60 at a position in which the planetary carrier 60 slides on a distal end of the sun gear portion 52. Each planetary gear 59 is interposed in the axial direction between a pair of plates 60a and 60b configuring the planetary carrier 60. Supporting shafts 61, which are supported by the plates 60a and 60b, are inserted along the axis of the planetary gears 59 so that the planetary gears 59 are supported rotatably about the supporting shafts 61. Therefore, each planetary gear 59 is rotatable about the corresponding supporting shaft 61 and revolutes along the ring gear portion 57 about the output shaft 49 in response to the rotation. At the same time, the planetary carrier 60 rotates integrally with the output shaft 49.

A planetary gear mechanism 50 is configured with the sun gear 51 (sun gear portion 52), the ring gear 55 (ring gear portion 57), the planetary gears 59, and the planetary carrier 60. As is enlarged in FIG. 9, each planetary gear 59 is formed to be cylindrical-shaped and includes an inner diameter larger than the outer diameter of the supporting shaft 61. Each planetary gear 59 includes a gear main body 59a, which forms an outer shape of the planetary gear 59 and is mostly made of resin material, and an elastic body 59b, which includes the inner diameter approximately identical to the outer diameter of the supporting shaft 61 and exhibits a ring shape along the inner periphery of the gear main body 59a. The elastic body 59b is made of elastic material. The gear main body 59a and the elastic body 59b are formed integrally for example by two-color-formation. An inner periphery of the elastic body 59b, which serves as an axis of the planetary gear 59, serves as a bearing bore 59c into which the supporting shaft 61 is fitted. As described above, the elastic body 59b is positioned at an axial portion of the planetary gear 59 such that the elastic body 59b absorbs fluctuations between each gear (sun gear 51, ring gear 55, planetary gears 59), which may occur in the event that the planetary gear mechanism 50 operates at a relatively low load. As illustrated in FIG. 9, the gear main body 59a is formed with a ring-shaped groove 59d at the axial both ends. The axial both ends of the elastic body 59b projects radially outwardly so as to fit into the groove 59d. Therefore, although the gear main body 59a and the elastic body 59b are made of materials that are not the same, the gear main body 59a and the elastic body 59b are integrated more firmly. As illustrated in FIG. 7, a drive lever 62, which is made of a plate and exhibits a fan-shaped structure, is firmly attached to the distal end of the output shaft 49 projecting outside of the housing 44. The drive lever 62 is formed with an arc-shaped guiding surface 62a interposed between two planar shaped guiding plates 63. FIG. 7 illustrates only one guiding plate 63. An end 35b of the outer tube 35 is supported by the supporting bracket 42 at the one side of the drive lever 62 (left in FIG. 7). The guiding plates 63 support the other end 36b of the drive wire 36, which is pulled out of the end 35b of the outer tube 35 and guided to the guiding surface 62a. Therefore, once the drive lever 62 is rotated in one direction (counterclockwise in FIG. 7) with the output shaft 49, the drive wire 36 is pulled out of the end 35b of the outer tube 35. In this case, the drive wire 36, which is supported at the side of the operation lever 31 is retracted into the end 35a of the outer tube 35. That is, a power transmitting means is configured with the drive lever 62, the drive cable 34, the operation lever 31 and so on.

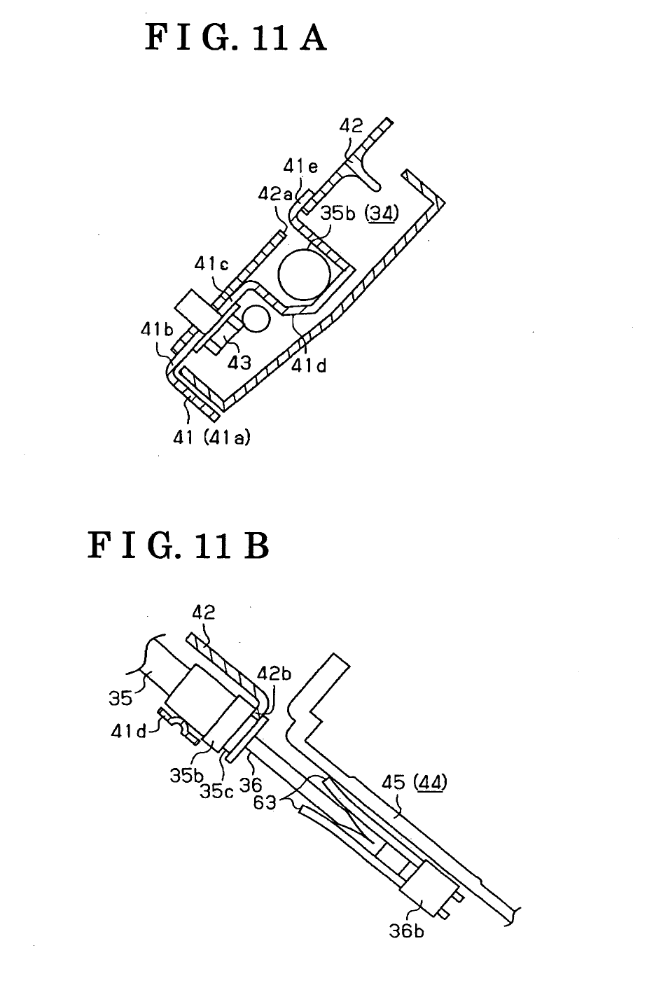

Described below is a mounting arrangement of the drive cable 34. FIGS. 11A and 11B are cross sectional views taken along lines XIA-XIA and XIB-XIB. As illustrated in FIG. 7, the bracket 41 is integrally provided with a wall portion 41b (supporting plate) formed at the end 41a of the bracket 41 and extending towards the electric motor 47. As illustrated in FIG. 11A, the wall portion 41b includes: a planar shaped fastened portion 41c; a U-shaped cross sectional housing portion 41d; and an engagement portion 41e. The planar-shaped fastened portion 41c lies on the supporting bracket 42 and is in contact therewith. The housing portion 41d is formed continuously at an end of the fastened portion 41c and extends away from the supporting bracket 42. The engagement portion 41e is bent from an opening end of the housing portion 41d and extends outwardly in parallel with the fastened portion 41c. The wall portion 41b of the bracket 41 is formed in a way that the engagement portion 41e projects in an opening direction of the housing portion 41d by a thickness of the supporting bracket 42.

Meanwhile, the supporting bracket 42 is formed with a square-shaped engagement hole 42a into which the engagement portion 41e is inserted. The wall portion 41b is fixed to the supporting bracket 42 with the fastened portion 41c fastened to the supporting bracket 42 by the screw 43 and with the engagement portion 41e inserted into the engagement hole 42a and is locked at the back surface of the supporting bracket 42 in a manner that the end 35b of the outer tube 35 (drive cable 34) lying on the supporting bracket 42 is surrounded by the housing portion 41d. Therefore, the end 35b of the outer tube 35 is surrounded by the inner wall surface of the housing portion 41d and a surface of the supporting bracket 42 such that the outer tube 35 is prevented from dropping in a radial direction.

As illustrated in FIG. 11B, the supporting bracket 42 is formed with a U-shaped guiding portion 42b to which a circular circumferential groove 35c of the end 35b of the outer tube 35 is mounted. The end 35b of the outer tube 35 is positioned in the axial direction with the circumferential groove 35c mounted at the guiding portion 42b.

As illustrated in FIG. 8A, the housing 45c is formed with a guiding groove 45g, which exhibits a rectangular shape and extends continuously to one side in parallel with a radial direction of the recess 45d. The housing 45c is further provided with a lever-side fan-shaped recess 45h continuously formed at an end of the guiding groove 45g. As illustrated in FIG. 9, the lever-side recess 45h is formed with a bearing bore 45i at the center of the fan-shape. The bearing bore 45i is fitted with one end of a lever shaft 66a integrally formed at a releasing lever 66 so as to be rotatable. The distal end of the lever shaft 66a projects outwardly from the case 45 (housing 44). The other end of the lever shaft 66a is supported by the recess 46b of the cover 46 so as to be freely rotatable and immovable to the axial one side (right in FIG. 9). The releasing lever 66 further includes a lever portion 66b and a cam hole 66c. The lever portion 66b exhibits a fan-shaped structure and extends toward the guiding groove 45g at the upper side in which the lever portion 66b does not interfere with the guiding groove 45g. The long cam hole 66c is formed at a distal end of the lever portion 66b and serves as a cam-side engagement portion. The cam hole 66c is bent in a way that one end of the cam hole 66c in the circumferential direction (the counterclockwise end in FIGS. 8A and 8B) is positioned closer to the lever shaft 66a rather than the other end thereof (the clockwise end in FIGS. 8A and 8B) is.

A lever biasing spring 67, which serves as biasing means, is supported, at its one end, by the inner wall surface at the one side (clockwise side in FIGS. 8A and 8B) of the housing 45c. The lever biasing spring 67 is wound about the lever shaft 66a with the other end of the lever biasing spring 67 engaged at the releasing lever 66 such that the releasing lever 66 is biased to pivot counterclockwise in FIGS. 8A and 8B. When a surface of the lever portion 66b comes in contact with a lever stopper 68 of the inner wall surface at the other side (counterclockwise side) of the housing 45c, the pivot rotation of the releasing lever 66 is restrained and the releasing lever 66 is retained at a predetermined pivot position.

Mounted on the guiding groove 45g is a canceling gear 69, which serves as a planar-shaped locking member movable in the radial direction of the recess 45d along the guiding groove 45g. The canceling gear 69 is formed with an engagement pin 69a and gear-side engagement nails 69b. The engagement pin 69a (a locking member-side engagement portion) projects toward the one side of the canceling gear 69 (toward the nearside in a perpendicular direction to a sheet of FIG. 8) and is inserted into the cam hole 66c. The gear-side engagement nails 69b are formed at a distal end of the canceling gear 69 at the recess 45d side and serves as multiple second engagement portions engageable with the engagement nails 58 facing the guiding groove 45g. As illustrated in FIG. 8A, in a state where the releasing lever 66 is retained at the predetermined pivot position with the surface of the lever portion 66b in contact with the lever stopper 68, the engagement pin 69a is pushed by the inner wall surface of the cam hole 66c and the canceling gear 69 is pushed towards the recess 45d, wherein the gear-side engagement nails 69b of the canceling gear 69 are engaged with the engagement nails 58 of the ring gear 55. Here, the ring gear 55 is locked to be against rotation. On the other hand, as illustrated in FIG. 8B, when the releasing lever 66 rotates clockwise against the biasing force of the lever biasing spring 67, the engagement pin 69a is pushed by the inner wall surface of the cam hole 66c, and the canceling gear 69 is retracted towards the lever shaft 66a, wherein the gear-side engagement nails 69b of the canceling gear 69 are disengaged from the engagement nails 58 of the ring gear 55. Here, the ring gear 55 is allowed to rotate.

As illustrated in FIG. 7, a lever 70, which is made of a plate, is fixed to a distal end of the lever shaft 66a, which distal end projects outwardly from the housing 44 (case 45). At the housing 44, an end 72a of an outer tube 72 of a canceling cable 71 is supported at the upper side of the lever 70. The lever 70 supports one end 73a of a wire 73 pulled out of the end 72a of the outer tube 72. Therefore, when the wire 73 is pulled into the end 72a of the outer tube 72, the lever 70 rotates with the releasing lever 66 counterclockwise in FIG. 7 (clockwise in FIGS. 8A and 8B) against the biasing force of the lever biasing spring 67. The wire 73 (canceling cable 71) is retracted towards the end 72a in a manner that the lever 70 rotates counterclockwise in FIG. 7 when either the outside door handle 4 or the inside door handle 5 is operated.

Described below is an operation of the actuator 40. In a state where the ring gear 55 is locked to be against rotation with the engagement nails 58 being engaged with the gear-side engagement nails 69b, the electric motor 47 is assumed to be actuated so as to transmit rotational torque to the sun gear 51 (worm wheel portion 54), which is in engagement with the worm 48 fixed to the rotation shaft 47a, for clockwise rotation in FIG. 8, the sun gear portion 52 naturally rotate in the same direction, clockwise in FIG. 8. Therefore, the planetary gears 59 revolute clockwise in FIG. 8 while rotating counterclockwise in FIG. 8 relative to the ring gear 55. The planetary carrier 60 outputs rotational force to the clockwise direction in FIG. 8. That is, the planetary gear mechanism 59 serves a speed reduction mechanism having the sun gear 51, the ring gear 55 and the planetary carrier 60 as an input shaft, a fixed shaft and an output shaft, respectively. Here, the drive lever 62 rotates counterclockwise in FIG. 7 in response to rotation of the output shaft 49 so that the drive wire 36 is pulled out of the end 35b of the outer tube 35. The ring gear 55 receives a reaction force of the planetary carrier 60 (output shaft 49) and is to rotate counterclockwise in FIG. 8. The canceling gear 69 however firmly restrains the ring gear 55 from rotating counterclockwise in FIG. 8.

On the other hand, in a state where the ring gear 55 is allowed to rotate with the engagement nails 58 in disengagement from the gear-side engagement nails 69b, the planetary carrier 60 (output shaft 49) is discontinued from outputting rotational force. This occurs because a large load is being applied to the side of the output shaft 49. That is, rotational torque, which is transmitted from the sun gear 51 to each planetary gear 59, is employed only for rotating the ring gear 55. As a result, each planetary gear 59 does not revolute thus not allowing the planetary carrier 60 to rotate.

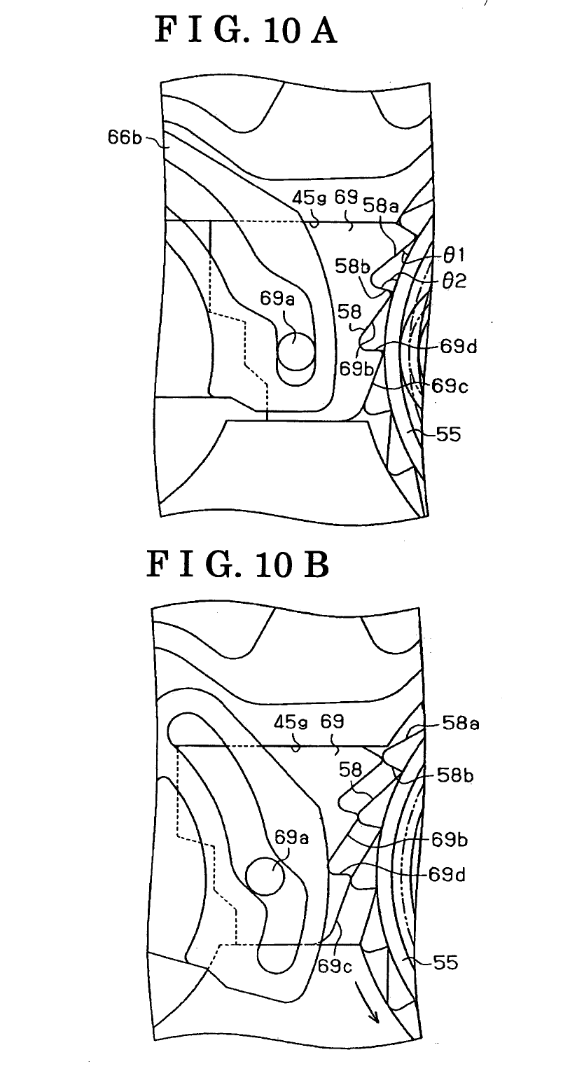

According to the embodiment of the present invention, the engagement nails 58 and the gear-side engagement nails 69b are each of a serration-type so that the nails 58 and 69b are smoothly gear-meshed with each other in a rotating direction of the ring gear 55. That is, as illustrated in FIG. 10, each engagement nail 58 includes a first straight inclined surface 58a, which slants to a tangential line of the ring gear 55 and defines an acute angle in a circumferential direction of the ring gear 55 (counterclockwise direction in FIG. 10), and a second straight inclined surface 58b, which slants to the tangential line of the ring gear 55 and defines an acute angle in the other circumferential direction of the ring gear 55 (clockwise direction in FIG. 10). The inclined surface 58b is formed continuously at a distal end of the first inclined surface 58a. An inclined angle θ 1, which is defined between the first inclined surface 38a and the tangential line of an outer periphery of the ring gear 55, is smaller than an inclined angle θ 2, which is defined between the second inclined surface 58b and the tangential line of the outer periphery of the ring gear 55. As described above, the ring gear 55 receives reaction force of the rotating planetary carrier 60 (output shaft 49) and can rotate counterclockwise in FIG. 10. The inclined angles θ 1 and θ 2 are determined corresponding to the rotational direction of the ring gear 55.

In the same manner as described above, each gear-side engagement nail 69b includes a first inclined surface 69c and a second inclined surface 69d so that the gear-side engagement nails 69b are engaged with the engagement nails 58. Therefore, when the ring gear 55 is about to rotate counterclockwise in FIG. 10, the ring gear 55 is locked against rotation because of a contact of the second inclined surfaces 58b and the second inclined surfaces 69d, both of which have sharp inclined angles, as illustrated in FIG. 10A. On the other hand, when the engagement nails 58 are re-engaged with the gear-side engagement nails 69b after disengagement, the engagement nails 58 and the gear-side engagement nails 69b may be shifted from desired original engagement positions, and each nail may run on a tooth top of a corresponding nail, as illustrated in FIG. 10B. Here, as the ring gear 55 rotates counterclockwise in FIG. 10B, the engagement nails 58 and the gear-side engagement nails 69b slowly slides on each other along the first inclined surfaces 58a and 69c and return to the original engagement positions. Therefore, the displacement of the engagement nails 58 and the gear-side engagement nails 69b from the original engagement positions is slowly absorbed.

As illustrated in FIG. 3, a releasing lever 76, which is made of a plate, is supported by the main body 11 to be pivotably rotatable about a second rotational axis O2, which is shifted from a first rotational axis O1 to the one side (left in FIG. 3). This releasing lever 76 is arranged to be shifted to an axially one side (toward the nearside in a perpendicular direction to a sheet of FIG. 3) relative to the open lever 12 and is formed with a plate-made cam portion 76a being bent to the other side (toward the nearside in a perpendicular direction to a sheet of FIG. 3) so as to be arranged on a pivot-movement path of the open lever 12 at the upper side of the other end 12b of the open lever 12. Therefore, as the open lever 12 pivots clockwise in FIG. 3 about the first rotational axis O1, the cam portion 76a comes in contact with a surface of the other end 12b of the open lever 12 and the releasing lever 76 pivots clockwise about the second rotational axis O2. In a state in which the open lever 12 is retained at the predetermined pivot position illustrated in FIG. 3, the releasing lever 76 is retained at a predetermined pivot position with the second rotational axis O2 while the cam portion 76a is in engagement with the other end 12b of the open lever 12. The releasing lever 76 is further formed with an attachment portion 76b extending to the one side thereof (left in FIG. 3), and the attachment portion 76b is lifted up in response to clockwise rotation of the releasing lever 76 about the second rotational axis O2.

In the main body 11, an end 72b of the outer tube 72 of the canceling cable 71 is supported at the lower side of the releasing lever 76 (attachment portion 76b). The attachment portion 76b of the releasing lever 76 supports the other end 73b of the wire 73 pulled out of the end 72b. Therefore, as the releasing lever 76 rotates clockwise in FIG. 3 about the second rotational axis O2, the wire 73 is pulled out of the end 72b of the outer tube 72. Here, the wire 73, which is supported at the side of the lever 70, is pulled into the end 72a of the outer tube 72. Therefore, the releasing lever 66 rotates against the biasing force of the lever biasing spring 67. The gear-side engagement nails 69b of the canceling gear 69 are disengaged from the engagement nails 58 of the ring gear 55 so that the ring gear 55 is allowed to rotate. That is, when either the outside door handle 4 or the inside door handle 5 is operated for a door opening operation, the attachment portion 76b is lifted up via the open lever 12. Therefore, the ring gear 55 is allowed to rotate and the planetary carrier 60 (output shaft 49) is discontinued from outputting rotational force. That is, releasing means is configured with the releasing lever 76, the releasing lever 66, the lever 70, the canceling cable 71 and so on. According to the embodiment of the present invention, the releasing lever 76, which is operatively associated with engagement or disengagement between the ring gear 55 and the canceling gear 69, is separated from the open lever 12. Therefore, even when a return operation of the releasing lever 76, which responds to releasing of a door handle operation, is implemented insufficiently, the insufficient return operation does not influence on a return operation of the open lever 12, i.e., a return operation of either the outside door handle 4 or the inside door handle 5.

Described below is an entire operation of the apparatus according to the embodiment of the present invention. First of all, the door 1 is assumed to be at the half-closed state or the fully closed state and the latch mechanism 20 is at the half-latched state or the fully latched state as illustrated in FIG. 5 or 6. In such circumstances, as the outside door handle 4 is manipulated for an opening operation of the door 1, this operation force of the outside door handle 4 is transmitted to the open lever 12. The open lever 12 then pivotably rotates about the first rotational axis O1 clockwise in FIG. 3 and the other end 12b of the open lever 12 is lifted up. The open link 14, which is illustrated in FIG. 4, is lifted in response to lifting of the other end 12b of the open lever 12 such that the distal end 15a of the lift lever 15 is pushed from below by the flange 14a of the open link 14. Therefore, the lift lever 15 rotates and the pole 24, which rotates integrally with the lift lever 15, rotates clockwise in FIG. 5 or 6, wherein the engagement of the engagement portion 24a with the first engagement portion 21d or the second engagement portion 21e is released. As a result, the latch 21 is biased by the latch biasing spring 22 and rotates clockwise in FIG. 5 or 6 while the inner wall surface of the engagement recess 21a is pushing the striker 3. The striker 3 is disengaged from the engagement recess 21a and the door 1 is allowed to open.

Meanwhile, as the inside door handle 5 is manipulated for an opening operation of the door 1, this operation force of the inside door handle 5 is transmitted to the inside open lever 16. The inside open lever 16 rotates about the rotational axis O counterclockwise in FIG. 4 and the distal end 16a is lifted up. The flange 14a of the open link 14 is pushed from below by the distal end 16a of the inside open lever 16. The open link 14 is lifted such that the pole 24 rotates integrally with the lift lever 15. Therefore, the striker 3 is disengaged from the engagement recess 21a of the latch 21 and the door 1 is allowed to open. Even when the inside open lever 16 rotates, the open lever 12 rotates lifting up the other end 12b in response to lifting of the open link 14.

Next, the door 1 is assumed to be at the half-closed state and the latch mechanism 20 is at the half-latched state as illustrated in FIG. 5. Besides, neither the inside door handle 4 nor the outside door handle 5 are operated, and the ring gear 55 is locked against rotation with the engagement nails 58 gear-meshed with the gear-side engagement nails 69b, as illustrated in FIG. 8A. Here, as the electric motor 47 is actuated and rotational torque is transmitted to the sun gear 51 clockwise in FIG. 8, the planetary carrier 60 (output shaft 49) outputs rotational power in the same direction, i.e., clockwise in FIG. 8. The drive lever 62 then rotates counterclockwise in FIG. 7 in response to the outputted rotational force. The drive wire 36 is hence pulled out of the end 35b of the outer tube 35 and is retracted into the end 35a of the outer tube 35 as illustrated in FIG. 5. As a result, the operation lever 31 is rotated clockwise in FIG. 5 and the striker 3 is pulled so as to engage with the engagement recess 21a of the latch 21, wherein the latch mechanism 20 is controlled to the fully latched state. The closing operation of the door 1 is implemented in a manner that the door 1 is shifted from the half-closed state to the fully closed state.

After the door 1 has completed at the fully closed state, the electric motor 47 is reverse-driven so as to rotate the drive lever 62, which rotates integrally with the output shaft 49 (planetary carrier 60), clockwise in FIG. 7. Here, because the electric motor 47 is driven at a relatively low load, the ring gear 55 is locked against rotation only with a small power of the canceling gear 69. The operation lever 31 is biased by the lever biasing spring and rotates counterclockwise in FIG. 6 while pulling the drive wire 36 from the end 35a of the outer tube 35a. The operation lever 31 is retained to the predetermined pivot position (original position) by the lever stopper 32. In such cases, the planetary gear mechanism 50 operates at a relatively low load. Although fluctuations may occur among each gear of the planetary gear mechanism 50 (sun gear 51, ring gear 55, planetary gears 59), such fluctuations are absorbed by the elastic body 59b.

Meanwhile, either the inside door handle 4 or the outside door handle 5 is assumed to have been operated for opening the door 1 while the electric motor 47 is activating, i.e., when the door 1 is closing. In such circumstances, the open lever 12 is transmitted with operation force of the door handle and is rotated about the first rotational axis O1 so as to lift the other end 12b of the open lever 12. The releasing lever 76 is pushed upward with the cam portion 76a in contact with the other end 12b and rotates about the second rotational axis O2 clockwise in FIG. 3, wherein the attachment portion 76b of the releasing lever 76 is lifted up. Accordingly, the wire 73 is pulled out of the end 72b and is retracted into the end 72a. Therefore, the releasing lever 66 is rotated clockwise in FIG. 8 integrally with the lever 70, and the gear-side engagement nails 69b of the canceling gear 69 are disengaged from the engagement nails 58 of the ring gear 55, wherein the ring gear 55 is allowed to rotate. The planetary carrier 60 (output shaft 49) is discontinued from outputting rotational force. Here, because the planetary gear mechanism 50 operates at a relatively low load, fluctuations may occur among gears of the planetary gear mechanism 50 (sun gear 51, ring gear 55, planetary gears 59). Such fluctuations are absorbed by the elastic body 59b. The latch mechanism 20 is shifted to the unlatched state in response to the door opening operation of either the inside door handle 4 or the outside door handle 5. The operation lever 31, which is in engagement with the latch 21 for shifting the latch from the half-latched state to the fully latched state, is disconnected from power transmission via the planetary gear mechanism 50, such that the operation lever 31 allows the latch mechanism 20 to shift to the unlatched state. As a result, the door 1 is allowed to open.

Once the inside door handle 4 or the outside door handle 5 is stopped from being operated in the above-described state, the releasing lever 66 is biased by the lever biasing spring 67 and returns to the predetermined pivot position. The canceling gear 69 moves along the guiding groove 45g in a way that the gear-side engagement nails 69b of the canceling gear 69 are engaged with the engagement nails 58 of the ring gear 55, wherein the ring gear 55 is locked against rotation. As the lever 70 rotates clockwise in FIG. 7 in response to rotation of the releasing lever 66, the wire 73 is pulled out of the end 72a of the outer tube 72 and is pulled into the end 72b. Therefore, when the releasing lever 76 rotate counterclockwise in FIG. 3, the cam portion 76a returns and is retained at the predetermined pivot position at which the cam portion 76a is engaged with the other end 12b of the open lever 12.

As described above, the following effects are obtained according to the embodiment of the present invention.

(1) The central engaged portion of the worm 48 and the worm wheel portion 54 and the central engaged portion of the sun gear 51 (sun gear portion 52), the ring gear 55 (gear portion 57) and the planetary gears 59 are arranged on the same plane P. The electric motor 47 is positioned on the basis of the rotational shaft 47a which defines the central engaged portion of the worm 48 and the worm wheel portion 54 such that the electric motor 47 is positioned so as not to away from the central engaged portion along the axial direction of the planetary gear mechanism 50. The entire thickness of the actuator 40 is reduced. Further, the assembling performance of the actuator 40 inside the door 1, in which an assembling space is limited, is enhanced.

Further, the central engaged portion of the worm 48 and the worm wheel portion 54 and the central engaged portion of the sun gear 51 (sun gear portion 52), the ring gear 55 (gear portion 57) and the planetary gears 59 are arranged on the same plane P. Therefore, it is possible to avoid occurrences of fluctuations or rattles of an axis which may occur due to torque generation associated with rotation transmission. This leads to reduction in load loss of rotational force transmission due to such fluctuation or rattles of the axis, and further leads to improvement in load efficiency of each component, which reduces a cost overall.

(2) The worm wheel portion 54 is formed at an outer peripheral surface of an enclosed portion, which exhibits a cylindrical shape with a bottom and houses the ring gear 55 therein, with a simple structure. Therefore, without interfering with the ring gear 55, the worm wheel portion 54 enables to position the central engaged portion of the worm 48 and the worm wheel portion 54 and the central engaged portion of the sun gear 51 (sun gear portion 52), the ring gear 55 (gear portion 57) and the planetary gears 59 on the same plane P.

(3) The door closing apparatus for a vehicle according to the embodiment of the present invention is provided with the actuator 40 that is thinner and downsized, which downsizing the door closing apparatus. Especially, when this type of door closing apparatus is mounted inside the door 1, a freedom for mounting the actuator 40 is enhanced in the thickness direction of the door 1.

Conventionally, according to JP2002-250165A, when torque transmission is disconnected between an electric motor and an output shaft in response to a door opening operation of a door handle, a canceling gear retracts and the engagement between its toothed portion and an external toothed portion of a ring gear is released. Here, the ring gear keeps rotating by a load-side inertia force and stops rotating with the external toothed portion being shifted from the original engagement position. Therefore, when the first and second engagement portions are re-engaged after releasing the operation of the door handle, each tooth may run on a tooth top of a corresponding tooth. Therefore, when rotational torque of the electric motor is inputted next, a canceling gear is occasionally dropped or depressed towards the ring gear suddenly by an amount at which the tooth have run on a corresponding tooth top, which may cause a noise (slapping sound). The door closing apparatus according to the embodiment of the present invention can restrain such noise occurrences at a time that the electric motor is driven.

(4) According to the embodiment of the present invention, the engagement nails 58 and the gear-side engagement nails 69b are each formed to have a serrated structure so that the engagement nails 58 and the gear-side engagement nails 69b are engaged smoothly in a rotational direction of the ring gear 55. Therefore, even if the above-described tooth running on each corresponding tooth top occurs, this tooth running, i.e., this shifting is absorbed when the sun gear 51 is rotated. As described above, it is possible to prevent occurrences of noise (e.g., slapping sound) which is created due to the sudden movement of the canceling gear 69 by an amount of such tooth running in the event that the engagement nails 58 and the gear-side engagement nails 69b return to the original engagement positions. Further, after the engagement nails 58 and the gear-side engagement nails 69b return to the original engagement positions, the ring gear 55 is locked so as not to rotate with the second inclined surfaces 58b and 69d being engaged.

(5) In a state where the ring gear 55 is locked against rotation, the planetary carrier 60 rotates at a slower speed than the rotating speed of the sun gear 51 actuated by the electric motor 47. Therefore, the planetary carrier 60 outputs higher rotational force. As a result, a power, which is required for shifting the door 1 from the half-closed state to the fully closed state, is obtained by a downsized electric motor 47.

(6) According to the embodiment of the present invention, the ring gear 55 is locked not to rotate with a simple structure. More specifically, the canceling gear 69 is movable to one or the other side along the radial direction of the ring gear 55, and the gear-side engagement nails 69b are engaged with or disengaged from the engagement nails 58. When the canceling gear 69 is moved to the one side, the gear-side engagement nails 69b are engaged with the engagement nails 58, in which the ring gear 55 is locked not to rotate. On the other hand, when the canceling gear 69 is moved to the other side, the gear-side engagement nails 69b are disengaged from the engagement nails 58, in which the ring gear 55 is allowed to rotate.

(7) According to the embodiment of the present invention, the releasing lever 66 is pivotably rotated with the engagement pin 69a fitted into or engaged with the cam hole 66c. A linear movement of the canceling gear 69, which is associated with the engagement and disengagement of the engagement nails 58 and the gear-side engagement nails 69b, is achieved with a simple structure by which the pivot rotation of the releasing lever 66 is converted to the linear movement of the canceling gear 69. When both of the handles 4 and 5 are released from being operated, the releasing lever 66 is biased by the lever biasing spring 67 so as to rotate in one direction, wherein the engagement nails 58 and the gear-side engagement nails 69b are engaged with each other and are retained in an engaged manner.

(8) According to the embodiment of the present invention, the door closing apparatus includes the wire 73 (canceling cable 71) which transmits the operation force of the door handle 4 or 5 to the canceling gear 69. Therefore, a location of the wire 73 effectively increases a freedom for placement of mechanical linkages between the canceling gear 69 and the door handles 4 and 5.

(9) According to the embodiment of the present invention, the drive wire 46 (drive cable 34) is provided, which transmits rotational power outputted from the planetary carrier 60 (output shaft 49) to the latch mechanism 20. Therefore, a location of the drive wire 36 effectively increases a freedom for placement of mechanical linkages between the planetary carrier 60 (planetary gear mechanism 50) and the latch mechanism 20.

According to the door closing apparatus disclosed in JP2002-250165A, when torque transmission is disconnected between an electric motor and an output shaft in response to an operation of a door handle for opening the door, a canceling gear retracts and its toothed portion is disengaged from an external toothed portion of a ring gear. Here, a planetary gear mechanism operates at a relatively low load. Likewise, when the output shaft (planetary gear mechanism) returns to the original rotational position, which is set before an electric motor is driven after completely shifting the door from the half-closed state to the fully closed state, the planetary gear mechanism is operated at a relatively low load. In general, a planetary gear mechanism is designed to have a backlash greater than a normal gear unit. Therefore, when the planetary gear mechanism is operated at a relatively low load, fluctuations among gears of the planetary gear mechanism may occur and a noise (gearing noise) may be created. However, according to the embodiment of the present invention, it is possible to restrain noise occurrences in the event that the planetary gear mechanism is operated at a relatively low load.

(10) According to the embodiment of the present invention, when the ring gear 55 is locked not to rotate with the canceling gear 69 engaged with the ring gear 55, the planetary carrier 60 (output shaft 49) outputs rotational force in response to a rotation of the sun gear 51. When this rotational power is transmitted to the latch mechanism 20, the door 1 is shifted from the half-closed state to the fully closed state. On the other hand, when the canceling gear 69 is transmitted with operation force of either the inside door handle 4 or the outside door handle 5 and the canceling gear 69 is disengaged from the ring gear 55, the ring gear 55 is allowed to rotate. As a result, the planetary carrier 60 (output shaft 49) stops outputting rotational power and the door 1 is discontinued from moving from the half-closed state to the fully closed state. Here, the planetary gear mechanism 50 is operated at a relatively low load, and fluctuations may occur among gears (sun gear 51, ring gear 55, planetary gears 59) of the planetary gear mechanism 50. Such fluctuations are absorbed by the elastic body 59b and noise (gearing sound) is prevented from occurring.

Further, in a situation where the door 1 has shifted from the half-closed state to the fully closed state, even when the planetary carrier 60 (planetary gear mechanism 50) is required to return to the original position, which is set before the electric motor is driven, for the purpose of returning the operation lever 31 to the original position, the planetary gear mechanism 50 is operated at a relatively low load. Even in this case, noise (gearing noise) can be prevented from occurring.

Still further, when the planetary carrier 60 (output shaft 49) outputs rotational force in order to shift the door 1 from the half-closed state to the fully closed state, each gear (sun gear 51, ring gear 55, planetary gears 59) of the planetary gear mechanism 50 rotates being pushed in one direction. Therefore, such noise may not occur.

(11) According to the embodiment of the present invention, the elastic body 59b is arranged at an axial portion of the sun gear 51 (sun gear portion 52), the ring gear 55 (gear portion 57) and the planetary gears 59. Therefore, it is possible to restrain occurrences of noise (gearing noise).

(12) According to the embodiment of the present invention, the wall portion 41b of the bracket 41 is fixed to the supporting bracket 42 with the fastened portion 41c being inserted into the engagement hole 42a. The fastened portion 41c is fixed to the supporting bracket 42. Therefore, the end 35b is housed in the housing portion 41d and is prevented from dropping in a radial direction between the supporting bracket 42 and the housing portion 41d. As described above, because the end 35b is retained only by fixing a single plate (wall portion 41b) to the supporting bracket 42, an assembling performance is enhanced. Further, the wall portion 41b is fixed to the supporting bracket 42 only by fastening the fastened portion 41c (one side of the wall portion 41b) to the supporting bracket 42, which improves workability.

(13) Especially, a direction for fastening the bolt approximately corresponds to a radial direction of the end 35b that has less limitation in a space, which improves workability. Further, it requires only a single bolt, which reduces the total number of components.

The following modifications are available. According to the embodiment of the present invention, torque transmission between the electric motor 47 and the sun gear 51 is achieved by a speed reduction gear set having the worm 48 and the worm wheel portion 54. Alternatively, torque transmission between the electric motor 47 and the sun gear 51 can be achieved by engaging helical gears. In this case, rotational speed, which is transmitted from the electric motor 47 to the sun gear 51, can be reduced, increased or maintained at the same speed level.

According to the embodiment of the present invention, the cam hole 66c and the engagement pin 68a, which are associated with an engagement between the releasing lever 66 and the canceling gear 69, can be formed at the side of the canceling gear 69 and the releasing lever 66, respectively.

According to the embodiment of the present invention, the drive cable 34 is provided, which connects the operation lever 31 of the door latch unit 10 and the drive lever 62 of the actuator 40 and transmit driving force. Alternatively, the operation lever 31 and the drive lever 62 can be gear-connected directly or can be connected via a linking mechanism so as to transmit driving force.

According to the embodiment of the present invention, the canceling cable 71 is provided, which connects the releasing lever 76 and the lever 70 of the actuator 40, which are associated with opening operations of the door handles 4 and 5. Alternatively, the releasing lever 76 and the lever 70 can be gear-connected directly or connected via a linking mechanism so as to transmit operation force.

According to the embodiment of the present invention, the sun gear 51, the ring gear 55 and the planetary carrier 60 can be any of the input shaft, the fixed shaft and the output shaft which all are different.

According to the embodiment of the present invention, the elastic body 59b, which is arranged at an axial portion of each planetary gear 59, is secured to the side of each planetary gear 59 (gear main body 59a). Alternatively, the elastic body 59b can be secured to the side of the supporting shaft 61. Still alternatively, a bushing, which is made of an elastic material, can be interposed between the supporting shaft 61 and the planetary gear 59 without being secured to either of them.

According to the embodiment of the present invention, an elastic body can be arranged at an axial portion of the sun gear 51 (sun gear portion 52). In this case, the elastic body can be secured to the side of the sun gear 51 (bearing bore 52a) or can be secured to the side of the output shaft 49. Or, a bushing, which is made of an elastic material, can be interposed therebetween without being secured to either of them.

According to the embodiment of the present invention, an elastic body can be arranged at an axial portion of the ring gear 55 (gear portion 57). In this case, the elastic body can be secured to the side of the ring gear 55 (bearing bore 56a) or can be secured to the side of the housing 44 (projection 45f). Or, a bushing, which is made of an elastic material, can be interposed therebetween without being secured to either of them.

According to the embodiment of the present invention, an elastic material, which forms an elastic body, can be for example elastomer, natural rubber, synthetic rubber or the like.

According to the embodiment of the present invention, the sun gear 51, the ring gear 55 and the planetary carrier 60 can be any of the input shaft, the fixed shaft and the output shaft which all are different. However, in all cases, in order to perform power transmission reliably, it is preferable that an elastic body is positioned at an axial portion of the output shaft or the fixed shaft not at an axial portion of the input shaft.

According to the embodiment of the present invention, the housing portion 41d can be formed with a curved or bent portion, which elastically makes a contact with the end 35b. In this case, it is possible to absorb rattle or looseness of the drive cable 34 in the housing portion 41d.

According to the embodiment of the present invention, the wall portion 41b, which serves as a supporting plate, is formed integrally with the bracket 41 which secures and supports the actuator 40 at the door latch unit 10. However, the wall portion 41b can be a member separated from the bracket 41.

As described above, a driving mechanism includes: a drive gear fixed at a rotational shaft of a motor; a sun gear rotatably provided and having a gear portion engaged with the drive gear; a ring gear arranged coaxially with the sun gear, the ring gear being locked not to rotate relative to the sun gear and being allowed to rotate relative to the sun gear; a planetary gear engaged with the sun gear and the ring gear; and a planetary carrier arranged coaxially with the sun gear and connected to the planetary gear. The planetary carrier outputs rotational force in response to rotation and revolution of the planetary gear operatively associated with rotation of the sun gear and relative to the ring gear locked not to rotate. A central engaged portion of the driving gear and the gear portion and a central engaged portion of the sun gear, the ring gear and the planetary gear are arranged on the same plane.

As described above, the central engaged portion of the drive gear and the gear portion and the central engaged portion of the sun gear, the ring gear and the planetary gear (planetary gear mechanism) are arranged on the same plane. The motor is positioned on the basis of the rotational shaft defining the central engaged portion of the dive gear and the gear portion. Therefore, the motor is positioned not being shifted to one axial side of the planetary gear mechanism, wherein an entire thickness of the driving mechanism becomes thinner.

The central engaged portion between gears is an arbitrary position within a range in which the gears are in contact with each other and may not be the accurate center. Further, as described above, when the central engaged portions are arranged on the same plane, all the central engaged portions are positioned on a predetermined imaginary surface perpendicular to an axis within an axial range of the sun gear.

It is preferable that the sun gear has a cylindrical box-shaped portion with a bottom, the box-shaped portion housing the ring gear formed at an outer peripheral surface of the box-shaped portion.

According to this structure, the gear portion exhibits a simple structure and is formed in a manner that the central engaged portion of the drive gear and the gear portion is arranged on the same plane as the central engaged portion of the sun gear, the ring gear and the planetary gear, while not interfering with the ring gear.

It is preferable that a door closing apparatus includes the driving mechanism; a latch mechanism holding a door for a vehicle at a half-closed state and a fully closed state; power transmitting means for transmitting force outputted by the planetary carrier to the latch mechanism in a state where the locking member is engaged with the ring gear so that the latch mechanism is operated to shift the door from the half-closed state to the fully closed state; and releasing means for transmitting an operation force to a locking member and releasing an engagement between the locking member and the ring gear regardless of the force transmission by the power transmitting means.

According to the above-described structure, when the ring gear is locked not to rotate with the engagement portion being engaged with the locking member, the planetary gear mechanism is operated. Here, the sun gear is driven to rotate and rotational force is outputted from the planetary gear mechanism. The rotational force is then transmitted to the latch mechanism via the power transmitting means and the door is moved from the half-closed state to the fully closed state. On the other hand, when the operation force is transmitted to the locking member via the releasing means, the locking member is disengaged from the ring gear. The ring gear is hence allowed to rotate and the planetary carrier is discontinued from outputting rotational force, wherein the door closing operation, in which the door is moved from the half-closed state to the fully closed state, is stopped. Such door closing apparatus is provided with a thinner and downsized driving mechanism such that the apparatus itself is downsized. Especially, when such door closing apparatus is mounted inside the vehicle door, it is possible to enhance freedoms for placement in the thickness direction of the door, i.e., in a width direction of a vehicle.

Further, a door closing apparatus for a vehicle includes a planetary gear mechanism having a sun gear, a ring gear, a planetary gear and a planetary carrier. An input shaft is selected from among the sun gear, the ring gear, the planetary gear and is rotatably driven by an electric motor. A fixed shaft is selected from among the sun gear, the ring gear and the planetary gear and is different from the input shaft. An output shaft is selected from among the sun gear, the ring gear, the planetary gear and is different from the input shaft and the fixed shaft. The door closing apparatus for the vehicle further includes: a first engagement portion formed at the fixed shaft of the planetary gear mechanism; a latch mechanism holding a door of the vehicle at a half-closed state and a fully closed state; a locking member having a second engagement portion. The locking member locks the fixed shaft not to rotate with the second engagement portion engaged with the first engagement portion of the fixed shaft and unlocks the fixed shaft to rotate with the second engagement portion disengaged from the first engagement portion of the fixed shaft. The door closing apparatus still further includes power transmitting means for transmitting force outputted by the output shaft to the latch mechanism so that the latch mechanism is operated to shift the door from the half-closed state to the fully closed state in a state where the locking member is engaged with the ring gear; and switching means for switching an engagement or disengagement between the first engagement portion and the second engagement portion. The switching means releases an engagement between the first engagement portion and the second engagement portion by transmitting an operation force to the locking member and engages the first engagement portion and the second engagement portion by discontinuing transmission of the operation force to the locking member, regardless of the force transmission by the power transmitting means. The first engagement portion and the second engagement portion are formed in a serrated manner so that the first engagement portion and the second engagement portion are engaged smoothly in a rotational direction of the fixed shaft.

As described above, once the fixed shaft is locked not to rotate in response to the engagement between the first engagement portion and the second engagement portion, the planetary gear mechanism is operated. That is, the input shaft is driven to rotate and rotational force is outputted from the output shaft. When the latch mechanism is transmitted with rotational force via the power transmitting means, the door for the vehicle is operated from the half-closed state to the fully closed state. On the other hand, the first engagement portion is disengaged from the second engagement portion when the operation force is transmitted to the locking member via the switching means, wherein the fixed shaft is allowed to rotate. The output shaft then stops outputting rotational force and a door closing operation, in which the door is moved from the half-closed state to the fully closed state, is interrupted. After than, in response to releasing of the operation of the door handle, the first engagement portion and the second engagement portion are re-engaged each other by the switching means. Here, there are cases in which the first and second engagement portions are shifted from the original engagement position and each tooth may run on a corresponding tooth top. However, according to the embodiment of the present invention, the first and second engagement portions are formed in a serrated manner so as to be engaged with each other smoothly in a rotational direction of the fixed shaft. Therefore, such tooth-shifting amount can be absorbed smoothly. As a result, when the first and second engagement portions return to original engagement positions, it is possible to restrain occurrences of noise (slapping sound) which may occur in the invent that the locking member moves suddenly by the tooth-shifting or running amount.

It is preferable that the input shaft, the fixed shaft and the output shaft are the sun gear, the ring gear and the planetary carrier, respectively.

According to this structure, when the ring gear is locked against rotation, the planetary carrier rotates slowly relative to the sun gear driven to rotate by the electric motor and obtains higher rotational torque. Therefore, power, which is required to move the door from the half-closed state to the fully closed state, is obtained by a downsized electric motor.

It is preferable that the locking member is provided to be movable in a radial direction of the fixed shaft, the second engagement portion of the locking member is engaged with the first engagement portion in response to a movement of the locking member to a radial one side of the fixed shaft and is disengaged from the first engagement portion in response to a movement of the locking member to the other radial side of the fixed shaft.

According to this structure, the first and second engagement portions are engaged with each other with a simple structure in which the locking member is moved to the radial one side of the fixed shaft, wherein the fixed shaft is locked not to rotate. Meanwhile, the first and second engagement portions are disengaged from each other with a simple structure in which the locking member is moved to the radial other side of the fixed shaft, wherein the fixed shaft is allowed to rotate.

It is preferable that the locking member includes a locking member-side engagement portion, the switching means includes a cam-side engagement portion engageable with the locking member-side engagement portion. The door closing apparatus can further includes: a cam member rotated in one direction and moving the locking member to the radial one side of the fixed shaft so that the second engagement portion of the locking member is engaged with the first engagement portion of the fixed shaft and rotated in the other direction on the basis of the operation force and moving the locking member to the radial other side of the fixed shaft so that the second engagement portion of the locking member is disengaged from the first engagement portion of the fixed shaft; and biasing means for biasing the cam member to rotate in the one direction.

According to this structure, a linear movement of the locking member, which is associated with the engagement and disengagement of the first and second engagement portions, is achieved with a simple structure by which the pivot rotation of the cam member is converted to the linear movement of the locking member. When the operation force transmission is disconnected, the cam member is biased by the biasing means so as to rotate in one direction, wherein the first and second engagement portions are engaged with each other and are retained in an engaged manner.

It is preferable that the operation force is an operation force for operating a door handle in order to open the door, and the switching means has a wire for transmitting the operation force of the door handle to the locking member.

According to this structure, the switching means includes a wire for transmitting the operation force of the door handle to the locking member. Therefore, a location of the wire effectively increases a freedom for placement of mechanical linkages between the locking member and the door handle.

It is preferable that the power transmitting means includes a drive wire for transmitting the force outputted by the output shaft to the latch mechanism.

According to this structure, a location of the drive wire effectively increases a freedom for placement of mechanical linkages between the output shaft (planetary gear mechanism) and the latch mechanism. Especially, when this structure is employed, it is possible to enhance a freedom for placement of the apparatus itself.

Still further, a door closing apparatus for a vehicle includes: a planetary gear mechanism having a sun gear, a ring gear, a planetary gear and a planetary carrier. An input shaft is selected from among the sun gear, the ring gear, the planetary gear and is rotatably driven by an electric motor. A fixed shaft is selected from among the sun gear, the ring gear and the planetary gear and is different from the input shaft. The fixed shaft is locked not to rotate by being engaged with a locking member and is unlocked to rotate by being disengaged from the locking member. An output shaft is selected from among the sun gear, the ring gear, the planetary gear and is different from the input shaft and the fixed shaft. The door closing apparatus further includes: a latch mechanism holding a door of the vehicle at a half-closed state and a fully closed state; power transmitting means for transmitting force outputted by the output shaft to the latch mechanism so that the latch mechanism is operated to shift the door from the half-closed state to the fully closed state in a state where the locking member is engaged with the ring gear; and switching means for switching an engagement or disengagement between the locking member and the fixed shaft. The switching means releases an engagement between the locking member and the fixed shaft by transmitting an operation force to the locking member and engages the locking member and the fixed shaft by discontinuing transmission of the operation force to the locking member, regardless of the force transmission by the power transmitting means. The door closing apparatus further includes an elastic body provided at an axial portion of at least one of the sun gear, the ring gear and the planetary gear.

As described above, when the fixed shaft is locked against rotation with the engagement between the locking member and the fixed shaft, the planetary gear mechanism is operated. Therefore, the input shaft is driven to rotate and rotational force is outputted from the output shaft. When the rotational force is transmitted to the latch mechanism via the power transmitting means, the vehicle door is moved from the half-closed state to the fully closed state. On the other hand, when the operation force is transmitted to the locking member by the switching means, the engagement between the locking member and the fixed shaft is released. The fixed shaft is allowed to rotate, wherein the output shaft stops outputting rotational force and the door closing operation, in which the door is moved from the half-closed state to the fully closed state, is interrupted. Here, because the planetary gear mechanism operates at a relatively low load, fluctuations or rattles may occur between gears of the planetary gear mechanism (sun gear, ring gear and planetary gears). Such fluctuations or rattles are absorbed by the elastic member and noise (gearing sound) is prevented from occurring.

It is preferable that the elastic body is provided at the axial portion of the planetary gear. According to this structure, it is possible to restrain occurrences of noise (gearing sound).

It is preferable that the input shaft, the fixed shaft and the output shaft are the sun gear, the ring gear, and the planetary carrier, respectively.

According to this structure, in a state where the ring gear is locked not to rotate, the planetary carrier is rotated slower than the sun gear driven to rotate by the electric motor. Therefore, it is possible to obtain higher rotational torque. In such cases, power, which is required to shift the vehicle door from the half-closed state to the fully closed state, is obtained by a downsized electric motor.

It is preferable that the locking member is provided to be movable in a radial direction of the fixed shaft, the locking member is engaged with the fixed shaft by moving to a radial one side of the fixed shaft and is disengaged from the fixed shaft by moving to the other radial side of the fixed shaft.

According to this structure, the locking member is engaged and the fixed shaft is locked against rotation with a simple structure in which the locking member is moved to the radial one side of the fixed shaft. Meanwhile, the locking member is disengaged and the fixed shaft is unlocked against rotation with a simple structure in which the locking member is moved to the radial other side of the fixed shaft.

It is preferable that the locking member includes a locking member-side engagement portion and the switching means includes a cam-side engagement portion engaged with the locking member-side engagement portion. The door closing apparatus can further include: a cam member rotated in one direction and moving the locking member to the radial one side of the fixed shaft so that the second engagement portion of the locking member is engaged with the first engagement portion of the fixed shaft and rotated in the other direction on the basis of an operation force and moving the locking member to the radial other side of the fixed shaft so that the second engagement portion of the locking member is disengaged from the first engagement portion of the fixed shaft; and biasing means for biasing the cam member to rotate in the one direction.

According to this structure, a linear movement (movement to the radial one side or the radial other side of the fixed shaft) of the locking member, which is engaged or disengaged with the fixed shaft, is achieved with a simple structure by which the pivot rotation of the cam member is converted to the linear movement of the locking member. When the operation force transmission is stopped, the cam member is biased by the biasing means so as to rotate in one direction, wherein the lock member and the fixed shaft are engaged with each other and are retained in an engaged manner.

It is preferable that the operation force is an operation force for operating a door handle in order to open the door, and the switching means includes a wire for transmitting the operation force to the locking member.

According to this structure, a location of the wire effectively increases a freedom for placement of mechanical linkages between the locking member and the door handle.

It is preferable that the power transmitting means includes a drive wire for transmitting the force outputted by the output shaft to the latch mechanism.

According to this structure, a location of the drive wire effectively increases a freedom for placement of mechanical linkages between the output shaft (planetary gear mechanism) and the latch mechanism. Especially, when this structure is employed, it is possible to enhance a freedom for placement of the apparatus itself.

It is preferable that the latch mechanism is transmitted with a force via a drive cable so that the door is operated from the half-closed state to the fully closed state. The door closing apparatus can further includes: a base member having an engagement bore; and a supporting plate having: an engagement portion inserted into the engagement bore and engaged at the base member; a fastened portion fastened to the base member; and a housing portion for housing an end of the drive cable and preventing the end from dropping in a radial direction relative to the base member.

It is further preferable that the base member is formed with a guiding portion for positioning the end of the drive cable in an axial direction.

According to the above-described structure, the supporting plate is secured to the base member with the engagement portion inserted into the engagement bore and fixed to the base member and with the fastened portion fastened to the base member. The housing portion houses, therein, the end of the drive cable connected to the driving mechanism, wherein the end of the drive cable is prevented from dropping or moving away. As described above, the end portion of the drive cable is secured only by fixing a single plate (supporting plate) to the base member, the assembling performance is enhanced. Further, at securely positioning the supporting plate, the one side of the supporting plate is fixed, at one side via the engagement portion, to the base member and only the other side of the supporting plate is needed to be fastened to the base member via the fastened portion. Therefore, a good workability or performance can be obtained.

The principles, of the preferred embodiment and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A driving mechanism comprising:
a drive gear fixed at a rotational shaft of a motor;
a sun gear rotatably provided and having a gear portion engaged with the drive gear;
a ring gear arranged coaxially with the sun gear, the ring gear being locked not to rotate relative to the sun gear and being allowed to rotate relative to the sun gear;
a planetary gear engaged with the sun gear and the ring gear;
a planetary carrier arranged coaxially with the sun gear and connected to the planetary gear, the planetary carrier outputting rotational force in response to rotation and revolution of the planetary gear operatively associated with rotation of the sun gear and relative to the ring gear locked not to rotate; and
a central engaged portion of the driving gear and the gear portion and a central engaged portion of the sun gear, the ring gear and the planetary gear being arranged on the same plane.

2. A driving mechanism according to claim 1, wherein the sun gear has a cylindrical box-shaped portion with a bottom, the box-shaped portion housing the ring gear, the gear portion is formed at an outer peripheral surface of the box-shaped portion.

3. A door closing apparatus for a vehicle having the driving mechanism according to claim 1, comprising:
a latch mechanism holding a door for the vehicle at a half-closed state and a fully closed state;
a locking member engageable with or disengageable from the ring gear, the locking member locking the ring gear not to rotate by being engaged with the ring gear and unlocking the ring gear to rotate by being disengaged from the ring gear;
power transmitting means for transmitting force outputted by the planetary carrier to the latch mechanism in a state where the locking member is engaged with the ring gear so that the latch mechanism is operated to shift the door from the half-closed state to the fully closed state; and
releasing means for transmitting an operation force to the locking member and releasing an engagement between the locking member and the ring gear regardless of the force transmission by the power transmitting means.

4. A door closing apparatus for a vehicle, comprising:
a planetary gear mechanism having a sun gear, a ring gear, a planetary gear and a planetary carrier, an input shaft selected from among the sun gear, the ring gear, the planetary gear and rotatably driven by an electric motor, a fixed shaft selected from among the sun gear, the ring gear and the planetary gear and being different from the input shaft, an output shaft selected from among the sun gear, the ring gear, the planetary gear and being different from the input shaft and the fixed shaft;
a first engagement portion formed at the fixed shaft of the planetary gear mechanism;
a latch mechanism holding a door of the vehicle at a half-closed state and a fully closed state;
a locking member having a second engagement portion, the locking member locking the fixed shaft not to rotate with the second engagement portion engaged with the first engagement portion of the fixed shaft and unlocking the fixed shaft to rotate with the second engagement portion disengaged from the first engagement portion of the fixed shaft;
power transmitting means for transmitting force outputted by the output shaft to the latch mechanism so that the latch mechanism is operated to shift the door from the half-closed state to the fully closed state in a state where the locking member is engaged with the ring gear; and
switching means for switching an engagement or disengagement between the first engagement portion and the second engagement portion, the switching means releasing an engagement between the first engagement portion and the second engagement portion by transmitting an operation force to the locking member and engaging the first engagement portion and the second engagement portion by discontinuing transmission of the operation force to the locking member, regardless of the force transmission by the power transmitting means; and
the first engagement portion and the second engagement portion being formed in a serrated manner so that the first engagement portion and the second engagement portion are engaged smoothly in a rotational direction of the fixed shaft.

5. A door closing apparatus for a vehicle according to claim 4, wherein the input shaft, the fixed shaft and the output shaft are the sun gear, the ring gear, and the planetary carrier, respectively.

6. A door closing apparatus according to claim 4, wherein the locking member is provided to be movable in a radial direction of the fixed shaft, the second engagement portion of the locking member is engaged with the first engagement portion in response to a movement of the locking member to a radial one side of the fixed shaft and is disengaged from the first engagement portion in response to a movement of the locking member to the other radial side of the fixed shaft.

7. A door closing apparatus for a vehicle according to claim 6, wherein the locking member includes a locking member-side engagement portion, the switching means includes a cam-side engagement portion engageable with the locking member-side engagement portion, the door closing apparatus further comprising:
a cam member rotated in one direction and moving the locking member to the radial one side of the fixed shaft so that the second engagement portion of the locking member is engaged with the first engagement portion of the fixed shaft and rotated in the other direction on the basis of the operation force and moving the locking member to the radial other side of the fixed shaft so that the second engagement portion of the locking member is disengaged from the first engagement portion of the fixed shaft; and
biasing means for biasing the cam member to rotate in the one direction.

8. A door closing apparatus for a vehicle according to claim 4, wherein the operation force is an operation force for operating a door handle in order to open the door, and the switching means has a wire for transmitting the operation force of the door handle to the locking member.

9. A door closing apparatus for a vehicle according to claim 4, wherein the torque transmission means includes a drive wire for transmitting the force outputted by the output shaft to the latch mechanism.

10. A door closing apparatus for a vehicle, comprising:
a planetary gear mechanism having a sun gear, a ring gear, a planetary gear and a planetary carrier, an input shaft selected from among the sun gear, the ring gear, the planetary gear and rotatably driven by an electric motor, a fixed shaft selected from among the sun gear, the ring gear and the planetary gear and being different from the input shaft, the fixed shaft being locked not to rotate by being engaged with a locking member and being unlocked to rotate by being disengaged from the locking member, an output shaft selected from among the sun gear, the ring gear, the planetary gear and being different from the input shaft and the fixed shaft, the output shaft outputting a force;
a latch mechanism holding a door of the vehicle at a half-closed state and a fully closed state;
power transmitting means for transmitting force outputted by the output shaft to the latch mechanism so that the latch mechanism is operated to shift the door from the half-closed state to the fully closed state in a state where the locking member is engaged with the ring gear; and
switching means for switching an engagement or disengagement between the locking member and the fixed shaft, the switching means releasing an engagement between the locking member and the fixed shaft by transmitting an operation force to the locking member and engaging the locking member and the fixed shaft by discontinuing transmission of the operation force to the locking member, regardless of the force transmission by the power transmitting means; and
an elastic body provided at an axial portion of at least one of the sun gear, the ring gear and the planetary gear.

11. A door closing apparatus for a vehicle according to claim 10, wherein the elastic body is provided at the axial portion of the planetary gear.

12. A door closing apparatus for a vehicle according to claim 10, wherein the input shaft, the fixed shaft and the output shaft are the sun gear, the ring gear, and the planetary carrier, respectively.

13. A door closing apparatus for a vehicle according to claim 10, wherein the locking member is provided to be movable in a radial direction of the fixed shaft, the locking member is engaged with the fixed shaft by moving to a radial one side of the fixed shaft and is disengaged from the fixed shaft by moving to the other radial side of the fixed shaft.

14. A door closing apparatus for a vehicle according to claim 10, wherein the locking member includes a locking member-side engagement portion and the switching means includes a cam-side engagement portion engaged with the locking member-side engagement portion, the door closing apparatus further comprising:
a cam member rotated in one direction and moving the locking member to the radial one side of the fixed shaft so that the second engagement portion of the locking member is engaged with the first engagement portion of the fixed shaft and rotated in the other direction on the basis of an operation force and moving the locking member to the radial other side of the fixed shaft so that the second engagement portion of the locking member is disengaged from the first engagement portion of the fixed shaft; and
biasing means for biasing the cam member to rotate in the one direction.

15. A door closing apparatus for a vehicle according to claim 10, wherein the operation force is an operation force for operating a door handle in order to open the door, the switching means includes a wire for transmitting the operation force to the locking member.

16. A door closing apparatus for a vehicle according to claim 10, wherein the power transmitting means includes a drive wire for transmitting the force outputted by the output shaft to the latch mechanism.

17. A door closing apparatus for a vehicle according to claim 3, wherein the latch mechanism is transmitted with a force via a drive cable so that the door is operated from the half-closed state to the fully closed state, the door closing apparatus further comprises:
a base member having an engagement bore; and
a supporting plate having: an engagement portion inserted into the engagement bore and engaged at the base member; a fastened portion fastened to the base member; and a housing portion for housing an end of the drive cable and preventing the end from dropping in a radial direction relative to the base member.

18. A door closing apparatus according to claim 17, wherein the base member is formed with a guiding portion for positioning the end of the drive cable in an axial direction.

19. A door closing apparatus for a vehicle according to claim 4, wherein the latch mechanism is transmitted with a force via a drive cable so that the door is operated from the half-closed state to the fully closed state, the door closing apparatus further comprises:
a base member having an engagement bore; and
a supporting plate having: an engagement portion inserted into the engagement bore and engaged at the base member; a fastened portion fastened to the base member; and a housing portion for housing an end of the drive cable and preventing the end from dropping in a radial direction relative to the base member.

20. A door closing apparatus for a vehicle according to claim 10, wherein the latch mechanism is transmitted with a force via a drive cable so that the door is operated from the half-closed state to the fully closed state, the door closing apparatus further comprises:
a base member having an engagement bore; and
a supporting plate having: an engagement portion inserted into the engagement bore and engaged at the base member; a fastened portion fastened to the base member; and a housing portion for housing an end of the drive cable and preventing the end from dropping in a radial direction relative to the base member.
